(19) United States
(12) Patent Application Publication
(10) Pub. No.: US 2025/0334424 A1
(43) Pub. Date: Oct. 30, 2025

(54) COORDINATED MAP UPDATING AND VERSIONING FOR AUTONOMOUS SYSTEMS AND APPLICATIONS

(71) Applicant: NVIDIA Corporation, Santa Clara, CA (US)

(72) Inventors: Galen Collins, Seattle, WA (US); Razvan Orendovici, Seattle, WA (US)

(21) Appl. No.: 18/651,374

(22) Filed: Apr. 30, 2024

(51) Int. Cl. G01C 21/00

(52) U.S. Cl. CPC G01C 21/3896; G01C 21/3841

(57) ABSTRACT

In various examples, updates may be published for maps used by machines to navigate an environment without restricting use of previous versions of the maps that remain valid. For example, a map for a region of an environment may be updated to a new version, and compatibility information for the new version of the map may be published. The compatibility information may indicate whether the new version of the map is compatible with other maps for other regions. Additional compatibility information for the other maps may also be updated to indicate whether those other maps are compatible with the new version of the map and/or the previous versions of the map. In some examples, an index may be updated to indicate the new version of the map is the most current version, and the new version of the map may be made available for use by the machines.

### BACKGROUND

For an autonomous or semi-autonomous vehicle or machine to safely navigate through an environment, the vehicle may rely on maps-such as navigational, standard definition (SD), and/or high-definition (HD) maps-corresponding to an environment in which the vehicle intends to operate. Due to their detailed, three-dimensional, and/or high precision nature, these maps have proven effective for safe navigation of environments where map information is available. However, in some circumstances, an environment associated with a map may change, such as by changing locations of roads, lanes, traffic signals, traffic signs, parking spots, construction, static barriers or objects, and/or any other features associated with the environment. In such circumstances, it may be important for the map to be updated in order to reflect the changes to the environment.

However, when trying to update a map—or a portion of the map—conventional systems experience issues publishing a new version of the map while other operations are also attempting to update at the same time. Traditionally, these operations may be serialized such that they are performed one after another and then a release may be made after all operations have completed. The problem with this approach is that updates to the map may only be performed in batches, and individual updates may have to wait until all operations are applied in their specific order. Additionally, conventional systems experience issues publishing new versions of the map while previous versions of the map are still in use. For instance, when the new versions of the map are published, the previous versions of the map may still be in use by hundreds—or even thousands—of vehicles to navigate an environment. As such, publishing the new versions of the map may cause disengagements and/or other errors for those vehicles.

### SUMMARY

Embodiments of the present disclosure relate to coordinated map updating and versioning for autonomous and semi-autonomous systems and applications. The systems and methods described herein may be used, in some instances, to publish updates to maps that are to be used by machines (e.g., autonomous and/or semi-autonomous machines and/or vehicles) to navigate an environment without restricting use of prior versions of the maps that may remain valid, thereby reducing the potential of machine disengagements and/or other errors related to the map updates.

In contrast to conventional systems, the systems of the present disclosure, in some embodiments, are able to publish and/or release new versions of maps while previous versions of the maps are in use by strategically publishing, storing, and/or updating compatibility information associated with various map versions. For example, a map for a region of an environment may be updated to a new version, and first compatibility data for the new version of the map may be published. The first compatibility data may indicate whether the new version of the map is compatible with other maps for other regions of the environment (e.g., neighboring regions of the environment). Based at least on publishing the first compatibility data for the new version of the map, second compatibility data for the other maps may also be updated to indicate whether those other maps are compatible with the new version of the map and/or the prior versions of the map. In some examples, based at least on updating the second compatibility data for the other maps, an index may be updated to indicate the new version of the map is the most current version, and the new version of the map may be made available for use by the machines.

### BRIEF DESCRIPTION OF THE DRAWINGS

The present systems and methods for coordinated map updating and versioning for autonomous and semi-autonomous systems and applications are described in detail below with reference to the attached drawing figures, wherein:

FIG. 1 is a data flow diagram illustrating an example process for updating one or more maps corresponding to one or more regions of an environment, in accordance with some embodiments of the present disclosure;

FIG. 2 is an illustration of example maps that may be used by machines to navigate an environment, in accordance with some embodiments of the present disclosure;

FIG. 3A is an illustration of an example format that may be used for representing compatibility data, in accordance with some embodiments of the present disclosure;

FIG. 3B is an illustration of another example format that may be used for representing compatibility data, in accordance with some embodiments of the present disclosure;

FIG. 4 is a block diagram illustrating example detail associated with map indexes, in accordance with some embodiments of the present disclosure;

FIG. 5A is a pictorial flow diagram illustrating an example process for updating one or more maps corresponding to one or more regions of an environment, in accordance with some embodiments of the present disclosure;

FIG. 5B is an illustration of different versions of maps being provided to machines based on different factors, in accordance with some embodiments of the present disclosure;

FIG. 6 is a flow diagram illustrating an example method for updating one or more portions of a map used for navigating an environment, in accordance with some embodiments of the present disclosure;

FIG. 7 is a flow diagram illustrating an example method for storing and/or updating map compatibility data in association with updating one or more portions of a map, in accordance with some embodiments of the present disclosure;

FIG. 8A is an illustration of an example autonomous vehicle, in accordance with some embodiments of the present disclosure;

FIG. 8B is an example of camera locations and fields of view for the example autonomous vehicle of FIG. 8A, in accordance with some embodiments of the present disclosure;

FIG. 8C is a block diagram of an example system architecture for the example autonomous vehicle of FIG. 8A, in accordance with some embodiments of the present disclosure;

FIG. 8D is a system diagram for communication between cloud-based server(s) and the example autonomous vehicle of FIG. 8A, in accordance with some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

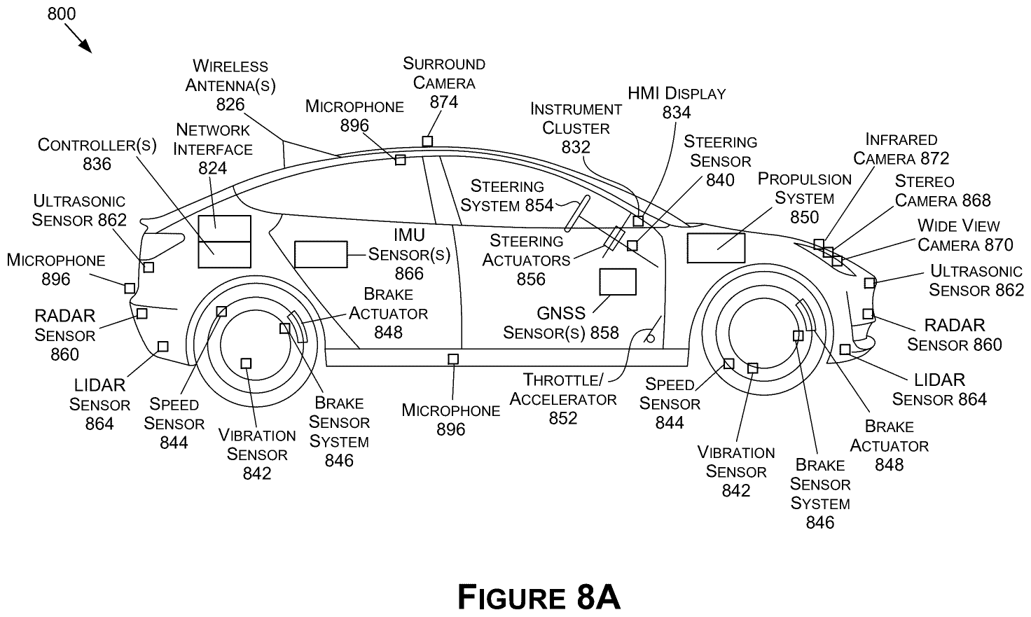

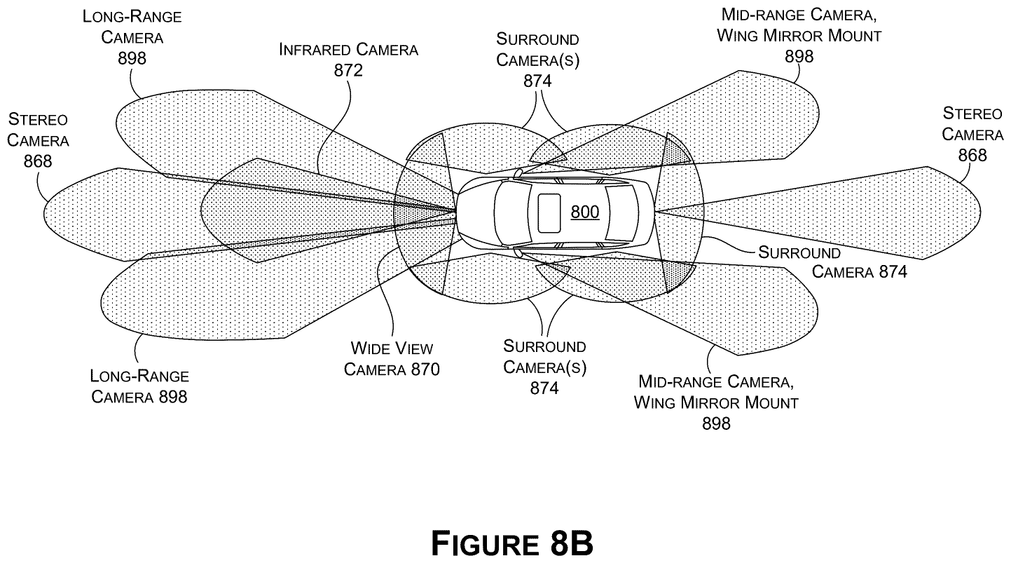

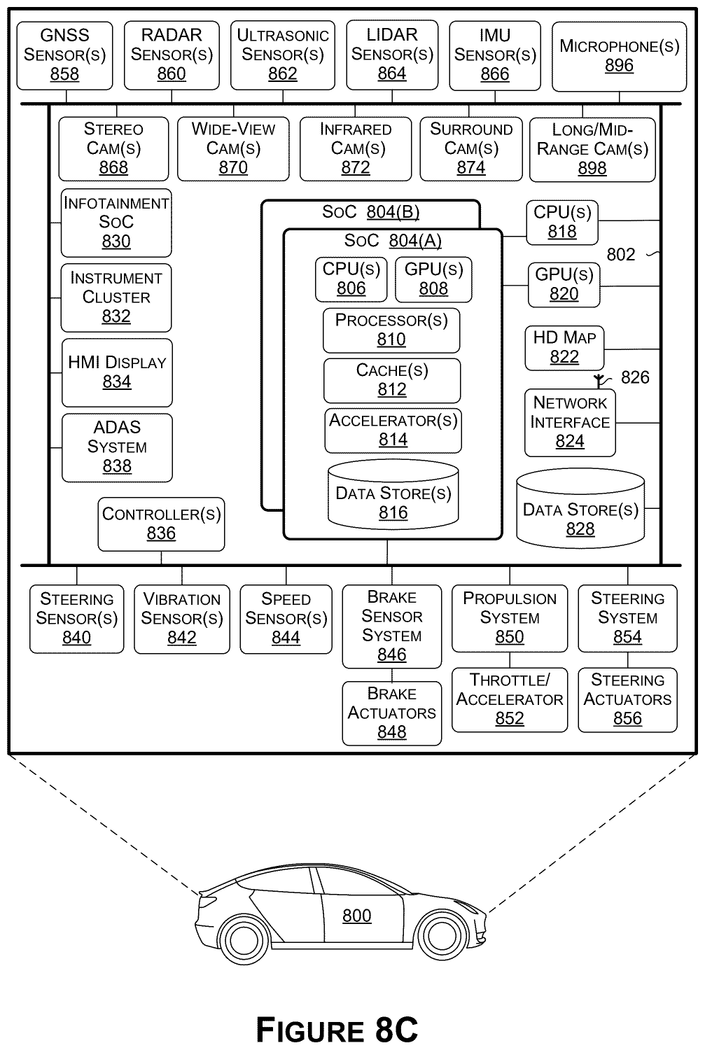

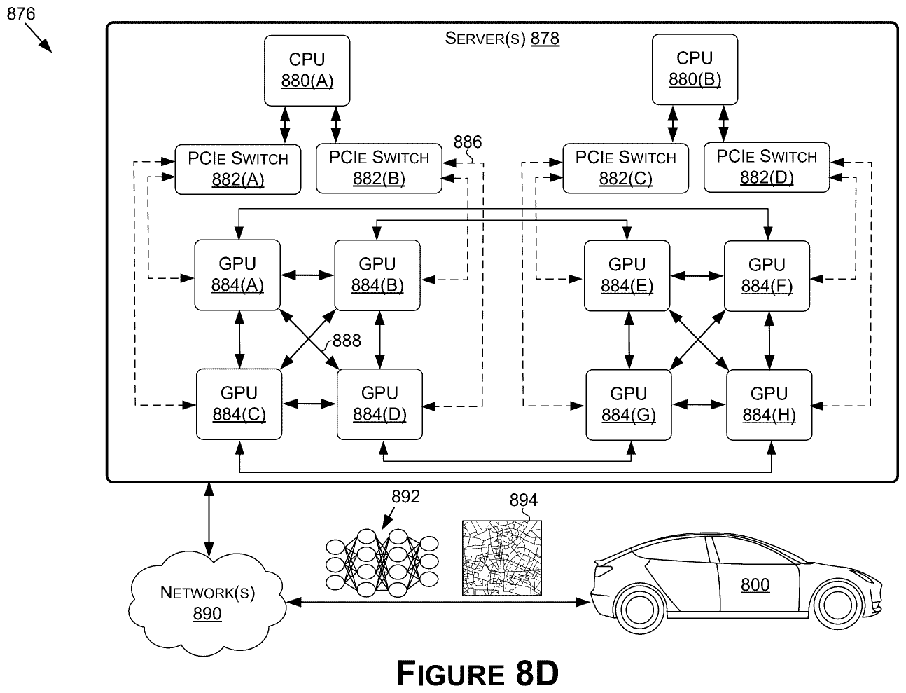

Systems and methods are disclosed related to coordinated map updating and versioning for autonomous and semi-autonomous systems and applications. Although the present disclosure may be described with respect to an example autonomous or semi-autonomous vehicle or machine 800 (alternatively referred to herein as “vehicle 800,” “ego-vehicle 800,” “ego-machine 800,” or “machine 800,” an example of which is described with respect to FIGS. 8A-8D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to autonomous or semi-autonomous machine applications, this is not intended to be limiting, and the systems and methods described herein may be used in augmented reality, virtual reality, mixed reality, robotics, security and surveillance, and/or any other technology spaces where object detection and/or map creation may be used.

For instance, a system(s) may cause one or more portions of one or more maps to be stored, wherein the portion(s) of the map(s) may be used by one or more autonomous and/or semi-autonomous machines to navigate an environment. In some examples, the portion(s) of the map(s) may correspond to one or more regions (e.g., geographic areas) of the environment. For instance, a first portion of the map(s) may correspond to a first region of the environment, a second portion of the map(s) may correspond to a second region of the environment, a third portion of the map(s) may correspond to a third region of the environment, and so forth. As such, the first portion of the map(s) may include first data (e.g., map data) representing a first map for the first region of the environment, the second portion of the map(s) may include second data representing a second map for the second region of the environment, and so forth. Additionally, in some examples, the system(s) may store, or cause to be stored, one or more versions of the portion(s) of the map(s). For instance, the system(s) may store one or more first versions associated with the portion(s) of the map(s), one or more second versions associated with the portion(s) of the map(s), one or more third versions associated with the portion(s) of the map(s), and so forth. The various version(s) of the portion(s) of the map(s) may include one or more different features between versions based on changes in the environment (e.g., addition of roads, abandonment of roads, changes to lanes, etc.).

As described herein, the system(s) may publish (e.g., store) compatibility information (also referred to herein as “compatibility data”) associated with the version(s) of the portion(s) of the map(s). The compatibility information may, in some examples, indicate which version(s) of the portion(s) of the map(s) is compatible with one another. For instance, compatibility data for a first version of a first portion of a map may indicate that the first version of the first portion of the map is compatible with a version of a second portion of the map, a version of a third portion of the map, a version of a fourth portion of the map, and so forth. Additionally, or alternatively, the compatibility data may indicate that a version of one portion of the map is compatible with one or more different versions of one or more other portions of the map. For instance, the compatibility data for the first version of the first portion of the map may additionally, or alternatively, indicate that the first version of the first portion of the map is compatible with a current version and/or one or more prior versions of the second portion of the map, and so forth for the third portion of the map, the fourth portion of the map, etc.

By way of example, and not limitation, the system(s) may, in accordance with aspects of the present disclosure, determine that a first portion of a map has been updated from a first version to a second version. The first portion of the map may correspond to a first region of an environment. In some examples, the first version may correspond to a present version (e.g., an in-use version) of the first portion of the map and the second version may correspond to a latest version (e.g., a most up-to-date version) of the first portion of the map. In some examples, the system(s) may generate the second version of the first portion of the map based at least on data obtained using the machine(s). For example, the system(s) may receive the data (e.g., sensor data, perception data, map stream data, etc.) from the machine(s) operating in the portion(s) of the environment. The system(s) may then, in some examples, determine to update the first portion of the map using the received data based at least on one or more events being detected. For example, the system(s) may update the first portion of the map based on a number of drives associated with the received data satisfying (e.g., being equal to or greater than) a threshold number of drives, a threshold period of time elapsing since a last update, receiving an indication to update the first portion of the map, and/or based on any other event. Details about determining when to update portions of maps and/or performing processes to update portions of maps is described more in U.S. patent application Ser. No. 18/538,558, which is incorporated herein by reference in its entirety and for all purposes.

In some examples, the system(s) may then generate and/or store first compatibility data in association with the second version of the first portion of the map. The first compatibility data may indicate, in some examples, that the second version of the first portion of the map is compatible with one or more second portions of the map. Additionally, the first compatibility data may indicate one or more respective versions of the second portion(s) of the map that are compatible with the second version of the first portion of the map. For instance, the first compatibility data may indicate that the second version of the first portion of the map is compatible with one or more first versions and/or one or more second versions of the second portion(s) of the map.

As described herein, the second portion(s) of the map may correspond to one or more second regions of the environment. In some examples, the second region(s) of the environment may be located proximate the first region of the environment corresponding to the first portion of the map. For instance, the second region(s) of the environment may include a neighboring region(s) that is/are adjacent to the first region. Additionally, or alternatively, the second region(s) of the environment may include one or more regions located diagonally across (e.g., kitty-corner) from the first region.

In some examples, the first compatibility data may be represented using a matrix-type data structure, which may be referred to herein as a “compatibility matrix.” For example, a first compatibility matrix representing the first compatibility data associated with the second version of the first portion of the map may include a 3×3 matrix. In some examples, the center portion of this 3×3 matrix may correspond to the second version of the first portion of the map and the outer portions of the 3×3 matrix may correspond to the second portion(s) of the map and/or their respective versions that are compatible with the second version of the first portion of the map. While the above first compatibility matrix is described as being a 3×3 matrix, any size of matrix may be possible (e.g., 2×2, etc.). Additionally, in some examples three-dimensional (3D) matrices may be used (e.g., 2×2×2, 3×3×3, etc.) to apply the techniques disclosed herein to 3D space and account for altitude.

In some examples, the first compatibility data may be stored by the system(s) in a first index. The first index may correspond to a versioned index that may be configured to store at least compatibility information for the different versions of the different portions of the map. For instance, the versioned index may store the first compatibility data for the second version of the first portion of the map, second compatibility data for the second portion(s) of the map, third compatibility data for the first version of the first portion of the map, etc. In other words, the first index (e.g., versioned index) may store compatibility information for some or all of the different versions of the different portions of the map.

In some instances, the system(s) may update second compatibility data associated with the second portion(s) of the map. The second compatibility data may be updated based at least on the system(s) storing (e.g., and/or completing the storing of) the first compatibility data in the first index. The second compatibility data may be stored in the first index and/or a second index. The second index may correspond to a latest index that may be configured to store at least the latest (e.g., most up-to-date) compatibility data for the various portions of the map. In some examples, the system(s) may update the second compatibility data to indicate whether the second portion(s) of the map is compatible with the first version and/or the second version of the first portion of the map.

For example, prior to the first portion of the map being updated from the first version to the second version, the second portion(s) of the map may have been compatible with the first version of the first portion of the map, and the second compatibility data may have indicated this compatibility. However, after being updated to the second version, the second portion(s) of the map may, or may not, still be compatible with the first portion of the map. As such, the system(s) may update the second compatibility data to indicate whether the second portion(s) of the map is compatible with the first version, the second version, and/or another version of the first portion of the map. In some examples, the second compatibility data may be updated in the first index and/or the second index.

The system(s) may also update the second index (e.g., latest index) to indicate that the second version of the first portion of the map is the latest version of the first portion of the map. In some examples, the system(s) may update the second index by publishing the first compatibility data to the second index, removing first data associated with the first version of the first portion of the map from being stored in the second index, storing second data associated with the second version of the first portion of the map in the second index (e.g., replacing the first data with the second data), and/or the like. In some instances, the second index may be updated by the system(s) based at least on the second compatibility data for the second portion(s) of the map being updated. That is, the system(s) may update the second index to indicate the second version of the first portion of the map is the latest version of the first portion of the map at least partially responsive to updating—or completing the updating of—the second compatibility data for the second portion(s) of the map.

In various examples as described herein, the system(s) may store and/or update different compatibility information at different times to allow the machine(s) to use different map versions for navigation without causing disengagement events (e.g., causing the machine(s) to stop operating). For example, the system(s) may store the first compatibility data for the second version of the first portion of the map in the first index at a first time, update the second compatibility data for the second portion(s) of the map at a second time after the first time, and update the second index to indicate the second version is the latest version of the first portion of the map at a third time after the second time. In this way, machine(s) that may be actively relying on an older version(s) of a map may continue navigating the environment without having to disengage to update map data.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

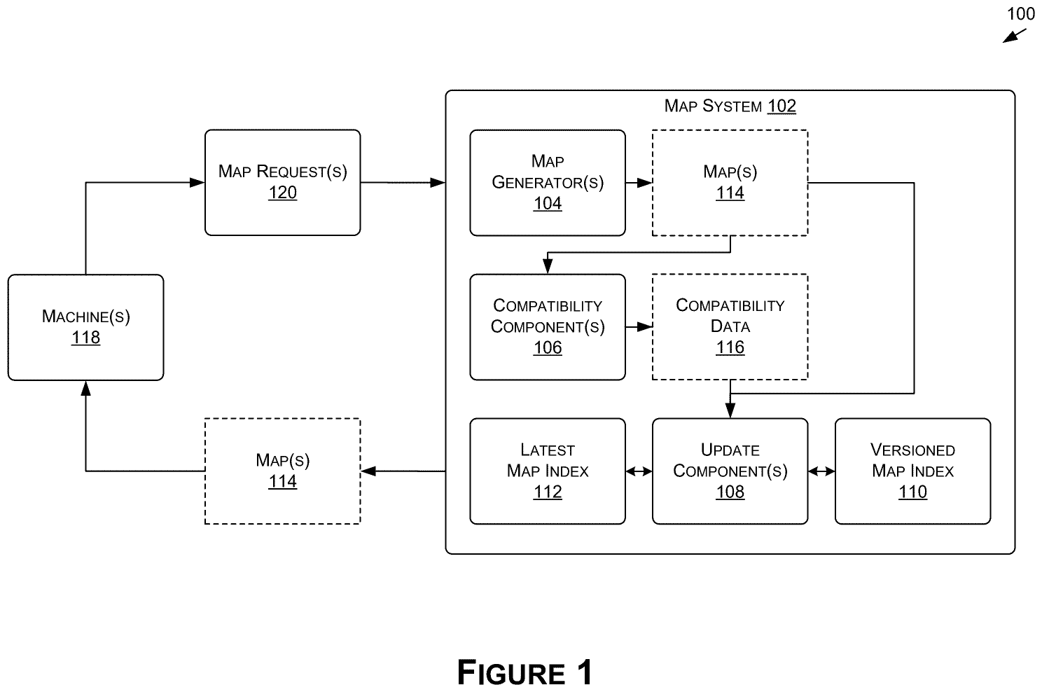

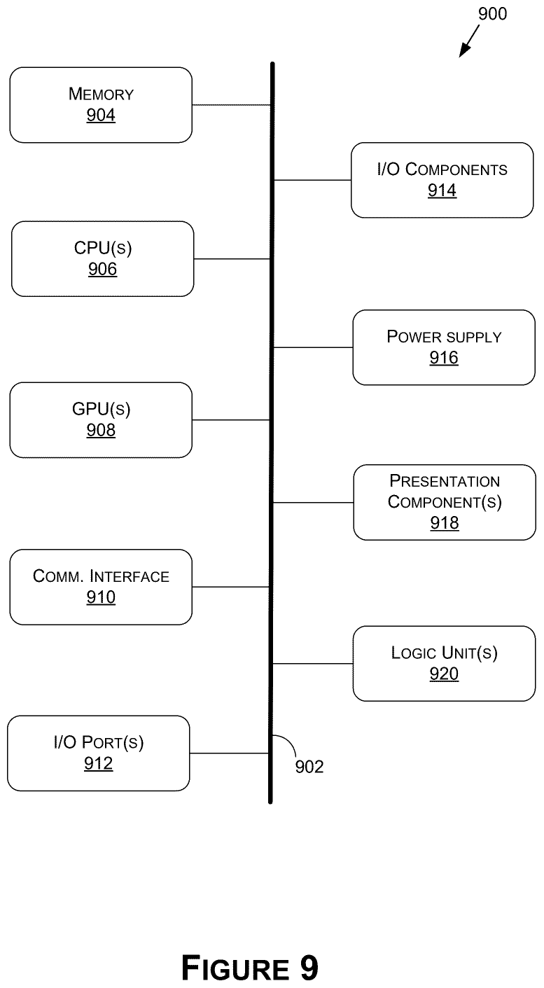

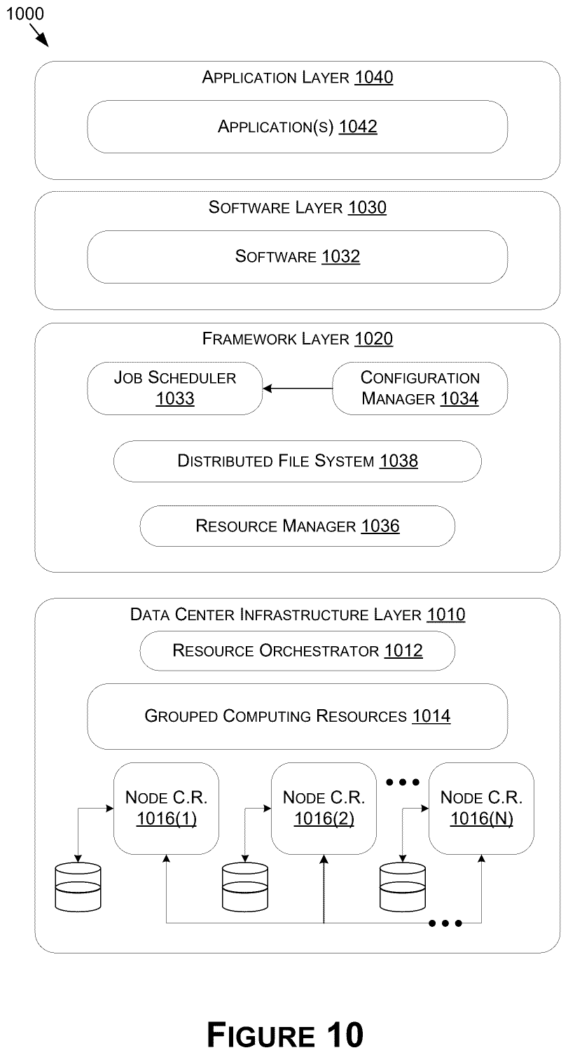

With reference to FIG. 1, FIG. 1 is a data flow diagram illustrating an example process 100 for updating one or more maps corresponding to one or more regions of an environment, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 800 of FIGS. 8A-8D, example computing device 900 of FIG. 9, and/or example data center 1000 of FIG. 10.

The process 100 may include a map system 102 that includes one or more map generators 104, one or more compatibility components 106, one or more update components 108, a versioned map index 110, and a latest map index 112. The map generator(s) 104 may generate one or more maps 114, which may correspond to one or more regions of an environment. The compatibility component(s) 106 may analyze at least the map(s) 114 to determine compatibility data 116 associated with the map(s) 114, which may indicate whether a map for a first region is compatible with a map for one or more second regions (e.g., neighboring regions) of the environment. The map(s) 114 and/or the compatibility data 116 may then be provided to the update component(s) 108, which may publish the map(s) 114 and/or the compatibility data 116 to the versioned map index 110 and/or the latest map index 112. In some examples, one or more machines 118 may send, to the map system 102, one or more map requests 120 requesting that the map system 102 provide one or more of the map(s) 114 for use by the machine(s) 118 to navigate the environment. The map system 102 may then provide the requested map(s) 114 to the machine(s) 118.

As noted above, the map generator(s) 104 of the map system 102 may be configured to generate the map(s) 114. In some examples, the map generator(s) 104 may generate the map(s) 114 based at least on data obtained using the machine(s) 118. For example, the map system 102 may receive location data and/or a mapstream(s) from the machine(s) 118 navigating within the environment. In some examples, the location data may include, but is not limited to, GPS Data, GNSS data, pose data, coordinates data, trajectory data, and/or any other type of data that may be used to determine locations and/or orientations of the machine(s) 118 within the environment. Additionally, the mapstream(s) may include, but is not limited to, a stream of sensor data (e.g., image data, LiDAR data, RADAR data, etc.), perception outputs from one or more neural networks, and/or any other data generated by the machine(s) 118 while traversing a path through the environment. For example, the mapstream(s) may indicate at least locations, orientations, dimensions, types, and/or any other information associated with objects detected using the machine(s) 118 when navigating within the environment. As described herein, the objects may include, but are not limited to, roads, lane lines, traffic signs, traffic lights, wait conditions, parking locations, surfaces (e.g., building surfaces), and/or any other type of object that may be located within the environment. In some examples, the mapstream(s) may include the location data. For example, the mapstream(s) may be used to determine the locations and/or orientations of the machine(s) 118 when navigating within the environment.

In some examples, the map(s) 114 generated by the map generator(s) 104 may correspond to one or more respective regions (e.g., geographic areas) of the environment. For instance, the map(s) 114 may include a first map (e.g., a first map portion) that may correspond to a first region of the environment, a second map (e.g., a second map portion) that may correspond to a second region of the environment, a third map (e.g., third map portion) that may correspond to a third region of the environment, and so forth.

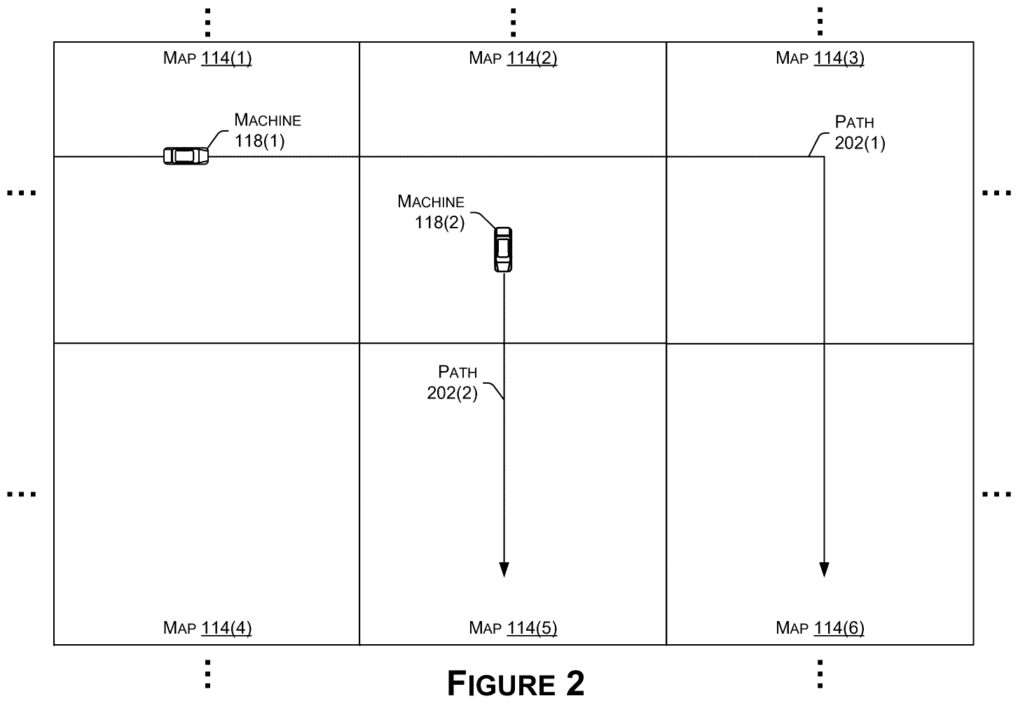

For instance, FIG. 2 is an illustration of example maps 114(1)-114(6) that may be used by machines 118(1) and 118(2) (also referred to in the singular and the plural as “machine(s) 118”) to navigate an environment, in accordance with some embodiments of the present disclosure. The maps 114(1)-114(6) may correspond to various portions of a larger, overall map of the environment. As an example, the maps 114(1)-114(6) may correspond to smaller areas of the environment, such as city blocks, districts, neighborhoods, zones, townships, subdivisions, etc., while the overall map may correspond to larger areas of the environment, such as counties, cities, states, countries, continents, etc. For example, the first map 114(1) may correspond to a first region of the environment (e.g., district one), the second map 114(2) may correspond to a second region of the environment (e.g., district two), the third map 114(3) may correspond to a third region of the environment (e.g., district three), the fourth map 114(4) may correspond to a fourth region of the environment (e.g., district four), the fifth map 114(5) may correspond to a fifth region of the environment (e.g., district five), and the sixth map 114(6) may correspond to a sixth region of the environment (e.g., district six).

The machines 118 may use the maps 114(1)-114(6) to navigate the regions of the environment corresponding to the maps 114(1)-114(6). For instance, based at least on the paths 202(1) and 202(2) (also referred to in the plural as “paths 202”) of the machine(s) 118, one or more of the maps 114(1)-114(6) may be downloaded or otherwise used by the machine(s) 118 to traverse the paths 202 through the environment. As an example, the first machine 118(1) may use the first map 114(1), the second map 114(2), the third map 114(3), and the sixth map 114(6) to traverse the first path 202(1). Similarly, the second machine 118(2) may use the second map 114(2) and the fifth map 114(5) to traverse the path 202(2). In some examples, the machine(s) 118 may use different versions of the maps 114(1)-114(6) to traverse the paths 202 during the same period of time. For instance, the first machine 118(1) may use a first version of the second map 114(2) to traverse the first path 202(1), while the second machine 118(2) may use a second version of the second map 114(2) to traverse the second path 202(2).

While the example of FIG. 2 illustrates six maps 114 associated with the environment and each having a square shape and equal size, any number of maps may be used to represent map data associated with an environment, and any number of shapes and/or sizes of maps may be used to represent the map data. Additionally, while the example of FIG. 2 illustrates two machines 118 using the maps 114 to traverse two paths 202 through the environment, in other examples, any number of machines may use any number of maps to traverse any number of paths through the environment.

Referring back to the example of FIG. 1, the process 100 may include the compatibility component(s) 106 generating the compatibility data 116 associated with the map(s) 114. The compatibility data 116 may, in some examples, indicate whether one or more first maps of the map(s) 114 is compatible with one or more second maps of the map(s) 114. For instance, compatibility data 116 for a first version of a first map of the map(s) 114 may indicate that the first version of the first map is compatible with a second version of a second map of the map(s) 114, a third version of a third map of the map(s) 114, a fourth version of a fourth map of the map(s) 114, and so forth. Additionally, or alternatively, the compatibility data 116 may indicate that a version of one map is compatible with multiple different versions of one or more other maps. For instance, the compatibility data 116 for the first version of the first map of the map(s) 114 may additionally, or alternatively, indicate that the first version of the first map is compatible with a multiple versions (e.g., a current version and/or one or more previous versions) of the second map of the map(s) 114, and so forth for the third map of the map(s) 114, the fourth map of the map(s) 114, etc.

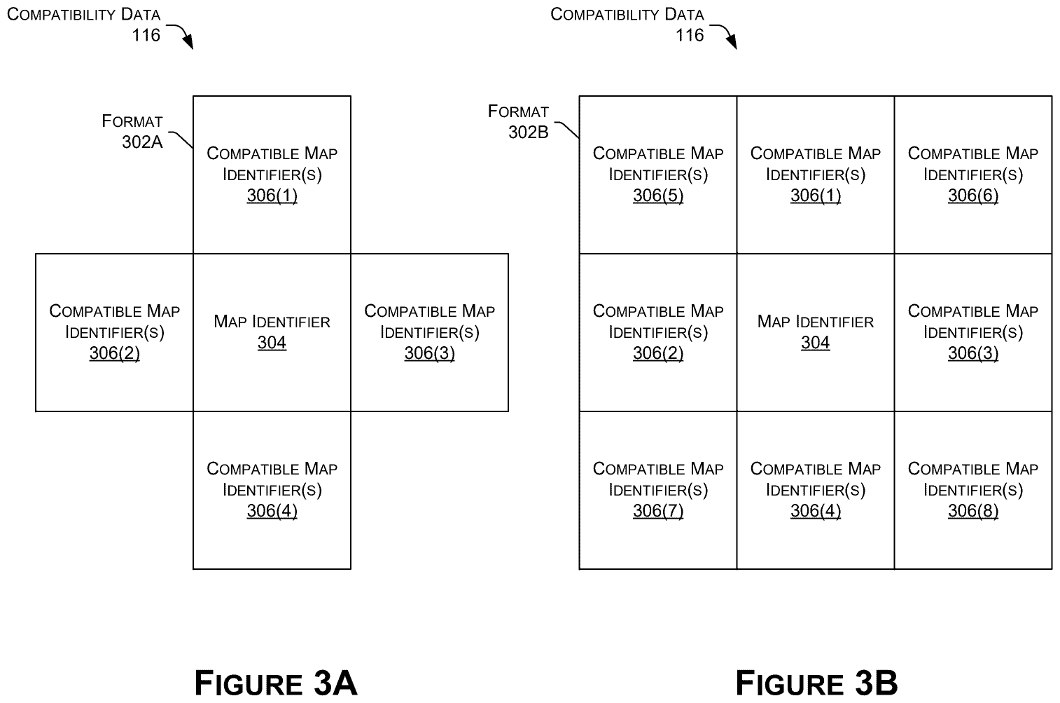

In some examples, the compatibility data 116 may be represented using various data structures. For instance, the compatibility data 116 may be represented using matrix-type data structures, which may be referred to herein as a “compatibility matrix.” For example, FIGS. 3A and 3B illustrate example data structure formats 302A and 302B that may be used for representing the compatibility data 116, in accordance with some embodiments of the present disclosure.

With reference to FIG. 3A, the first format 302A for representing the compatibility data 116 may include a map identifier 304 for the version of the map portion that the compatibility data 116 corresponds to. That is, if the compatibility data 116 is compatibility data for a current version of a map for Wyoming, then the map identifier 304 may correspond to a map identifier for the current version of the map for Wyoming. As shown, the map identifier 304 may be positioned at a center location of the first format 302A. The first format 302A may also include one or more compatible map identifiers 306(1)-306(4) (also referred to collectively as “compatible map identifiers 306”). In some examples, each of the compatible map identifiers 306 may indicate one or more identifiers of neighboring map versions that are compatible with the map version corresponding to the map identifier 304. Continuing the example from above in which the map identifier 304 corresponds to the current version of the map for Wyoming, the first compatible map identifier(s) 306(1) may include one or more identifiers for various versions of maps for Montana (e.g., a current version and one or more previous versions), the second compatible map identifier(s) 306(2) may include one or more identifiers for various versions of maps for Idaho, the third compatible map identifier(s) 306(3) may include one or more identifiers for various versions of maps for South Dakota, and the fourth compatible map identifier(s) 306(4) may include one or more identifiers for various versions of maps for Colorado. As another example, and with reference to FIGS. 2 and 3A, the map identifier 304 may correspond to the fifth map 114(5), the first compatible map identifier(s) 306(1) may correspond to the second map 114(2), the second compatible map identifier(s) 306(2) may correspond to the fourth map 114(4), and the third compatible map identifier(s) 306(3) may correspond to the sixth map 114(6).

With reference to FIG. 3B, the second format 302B for representing the compatibility data 116 may include the map identifier 304 for the version of the map portion that the compatibility data 116 corresponds to. The second format 302B may also include, in addition to the compatible map identifier(s) 306(1)-306(4), one or more fifth compatible map identifiers 306(5), one or more sixth compatible map identifiers 306(6), one or more seventh compatible map identifiers 306(7), and one or more eighth compatible map identifiers 306(8). That is, the format 302B may include compatible map identifiers 306 for the corners of the 3×3 matrix, which may correspond to regions of the environment that are located diagonally across (e.g., kitty corner) from the region corresponding to the map identifier 304. Continuing the example from above in which the map identifier 304 corresponds to the current version of the map for Wyoming, the fifth compatible map identifier(s) 306(5) may include one or more identifiers for various versions of maps for Western Montana, the sixth compatible map identifier(s) 306(6) may include one or more identifiers for various versions of maps for Northwest South Dakota and/or Southwest North Dakota, the seventh compatible map identifier(s) 306(7) may include one or more identifiers for various versions of maps for Utah, and the eighth compatible map identifier(s) 306(8) may include one or more identifiers for various versions of maps for Northeast Colorado. Additionally, to continue the other example from above with reference to FIGS. 2 and 3B, the fifth compatible map identifier(s) 306(5) may correspond to the first map 114(1) and the sixth compatible map identifier(s) 306(2) may correspond to the third map 114(3).

Although the map identifier 304 and the compatible map identifiers 306 are described in the examples of FIGS. 3A and 3B as being identifiers that correspond to maps associated with certain geographical areas and/or sizes (e.g., states) for explanatory purposes, the map identifier 304 and the compatible map identifiers 306 may correspond to any map for any geographical area and/or size. For example, while the map identifier 304 and the compatible map identifiers 306 are described as corresponding to maps of states or portions of states, the identifiers may correspond to smaller and/or larger geographic areas as well, including, but not limited to, continents, countries, states, provinces, counties, cities, districts, portions thereof, and/or any other geographical region.

Referring back to the example of FIG. 1, the process 100 may include the update component(s) 108 receiving the map(s) 114 and the compatibility data 116 associated with the map(s) 114. In some examples, the map(s) 114 and/or the compatibility data 116 may correspond to one or more new (e.g., updated) versions of one or more portions of the map, which may be associated with one or more regions of the environment. For example, the map(s) 114 may include an updated map for a first region of the environment and the compatibility data 116 may include compatibility information for the updated map. Additionally, or alternatively, the compatibility data 116 may include compatibility information for one or more versions of neighboring maps to the updated map.

Based at least on receiving the map(s) 114 and/or the compatibility data 116, the update component(s) 108 may update the versioned map index 110 and the latest map index 112. As described herein, to reduce the likelihood of disengagement or other adverse events for the machine(s) 118 caused by updates to the map(s) 114, the updated component(s) 108 and/or the map system 102 may intelligently update the versioned map index 110 and the latest map index 112 to ensure that previous versions of the map(s) 114, which may be in use by one or more of the machine(s) 118, are not rendered invalid and thereby cause machine disengagements. By way of example, and not limitation, the update component(s) 108 may first publish a new map and its corresponding compatibility information to the versioned map index 110. Then, the update component(s) 108 may update the compatibility information for one or more other maps (e.g., a neighboring map(s) of the new map) to indicate whether the other map(s) are compatible with the new map. The update component(s) 108 may then updated the latest map index 112 to replace a previous version of the map with the new map and/or its compatibility information. These operations will be discussed in further detail below.

In some examples, the versioned map index 110 may be configured to store at least compatibility data 116 for the different versions of the different map(s) 114. For instance, the versioned map index 110 may store first compatibility information for one or more first versions of one or more maps, second compatibility information for one or more second versions of the map(s), third compatibility information for one or more third versions of the map(s), etc. In other words, the versioned map index 110 may store the compatibility data 116 for some or all of the different versions of the map(s) 114. On the other hand, the latest map index 112 may be configured to store at least the latest (e.g., most up-to-date) map(s) 114 for the different regions of the environment. Additionally, or alternatively, the latest map index 112 may store the compatibility data 116 for the latest map(s) 114. In other words, as opposed to the versioned map index 110 that may store a more complete history of the different versions of the map(s) 114 and their corresponding compatibility data 116, the latest map index 112 may more simply store the latest map(s) 114 (e.g., single, current versions of the different maps for different regions) and their corresponding compatibility data 116.

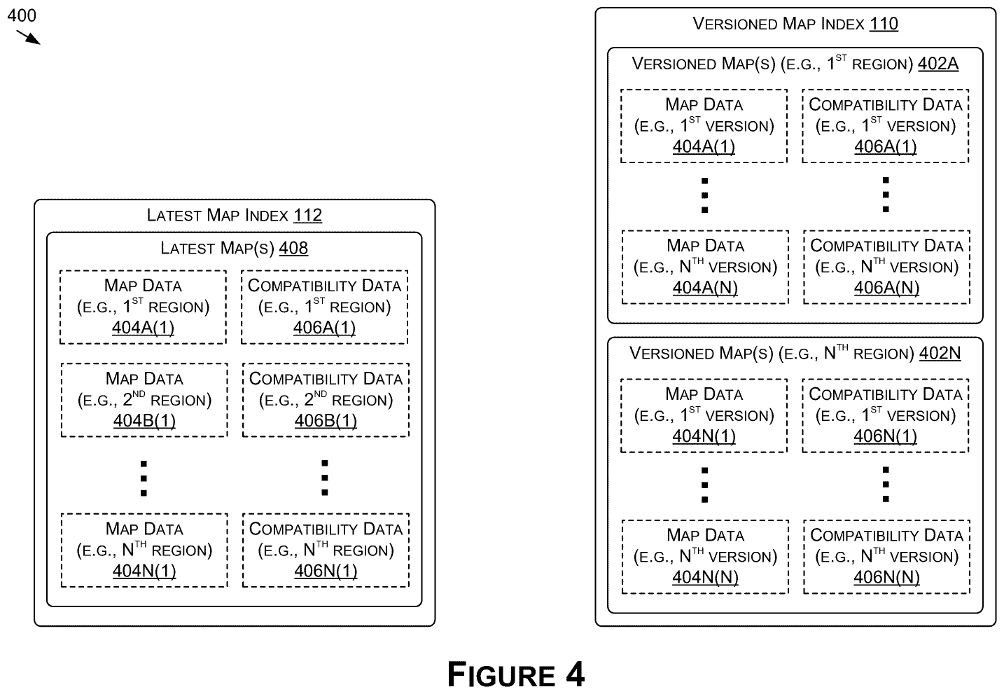

For instance, FIG. 4 is a block diagram illustrating example detail 400 associated with the versioned map index 110 and the latest map index 112, in accordance with some embodiments of the present disclosure. The versioned map index 110 may store one or more versioned maps 402A-402N, where “N” may represent any number of different portions of a map. In some examples, the versioned map(s) 402A may correspond to a first region of an environment and the versioned map(s) 402N may correction to an Nth region of the environment, where “N” may represent any number of regions. In some examples, map data 404A(1)-404A (N) and/or compatibility data 406A(1)-406A (N) may be stored in association with the versioned map(s) 402A for the first region. The compatibility data 406A(1) may correspond to the map data 404A(1) and the compatibility data 406A (N) may correspond to the map data 404A (N). Similarly, map data 404N(1)-404N (N) and/or compatibility data 406N(1)-406N (N) may be stored in association with the versioned map(s) 402N for the Nth region. The compatibility data 406N(1) may correspond to the map data 404N(1) and the compatibility data 406N (N) may correspond to the map data 404N (N).

In some examples, the compatibility data 406A(1) may indicate that the map data 404A(1) associated with a first version of the versioned map(s) 402A is compatible with one or more other versioned maps, such as the versioned map(s) 402N. Additionally, the compatibility data 406A(1) may indicate that the map data 404A(1) associated with the first version of the versioned map(s) 402A is compatible with one or more respective versions of the other versioned map(s), such as the map data 404N(1) associated with the first version of the versioned map(s) 402N and/or the map data 404N (N) associated with the Nth version of the versioned map(s) 402N.

Referring still to FIG. 4, the latest map index 112 may store one or more latest maps 408 for various regions of the environment. In some examples, the latest map(s) 408 may include one or more of the versioned map(s) 402A-402N. For example, the latest map(s) 408 of the latest map index 112 includes the map data 404A(1), which corresponds to the first version (e.g., latest version) map for the first region. Additionally, the latest map(s) 408 includes the map data 404B(1)—which may be a latest map version for a second region—and the map data 404N(1), which corresponds to the first version map for the Nth region. In some examples, the latest map index 112 may also store the compatibility data 406A(1)-406N(1) associated with the map data 404A(1)-404N(1).

In some examples, the versioned map(s) 402A-402N, the latest map(s) 408, and/or the map data 404A(1)-404N (N) may correspond to one or more of the map(s) 114 described in the example of FIG. 1. Additionally, the compatibility data 406A(1)-406N (N) may correspond to the compatibility data 116 described with reference to FIG. 1. Furthermore, although it has been described herein that the versioned map index 110 and/or the latest map index 112 may store maps and/or compatibility data, in some examples, the versioned map index 110 and/or the latest map index 112 may store data (e.g., pointers, metadata, etc.) indicating locations where the map(s) 114 and/or the compatibility data 116 are stored and/or may be accessed. Additional information relating to storing the map(s) and/or the compatibility data is described in U.S. patent application Ser. No. 17/670,294, which is incorporated herein by reference in its entirety and for all purposes.

Referring back to the example of FIG. 1, the process 100 may include the update component(s) 108 obtaining a first map of the map(s) 114 corresponding to a first region of the environment and first compatibility data of the compatibility data 116 for the first map. During a first period of time, the update component(s) 108 may publish the first map and/or the first compatibility data to the versioned map index. The first compatibility data may indicate that the first map is compatible with one or more versions of one or more second maps of the map(s) 114, which may already be published in the versioned map index 110 and/or the latest map index 112. In some examples, the second map(s) may correspond to one or more second regions of the environment proximate the first region (e.g., neighboring, adjacent, kitty corner, etc.)

In some examples, based at least on publishing the first map and/or the first compatibility data to the versioned map index 110, the process 100 may include the update component(s) 108 causing second compatibility data for the version(s) of the second map(s) to be updated. For instance, the update component(s) 108 may cause the second compatibility data for the version(s) of the second map(s) to be updated to indicate whether the version(s) of the second map(s) are compatible with the first map and/or one or more previous versions of the first map. In some examples, the update component(s) 108 may cause the second compatibility data for the version(s) of the second map(s) to be updated during a second period of time after the first period of time. In some examples, the update component(s) 108 may update the second compatibility data that is stored in the versioned map index 110 and/or the latest map index 112 in association with the version(s) of the second map(s).

In some instances, based at least on updating the second compatibility data for the version(s) of the second map(s), the update component(s) 108 may update the latest map index 112 to replace, as the latest version of the first map, a previous version of the first map with the new version of the first map. That is, the update component(s) 108 may update the latest map index to indicate that the first map is the latest map version for the first region of the environment. Additionally, the update component(s) may store or otherwise link the first compatibility information to the first map in the latest map index 112. In some examples, the update component(s) 108 may update the latest map index 112 during a third period of time after the second period of time.

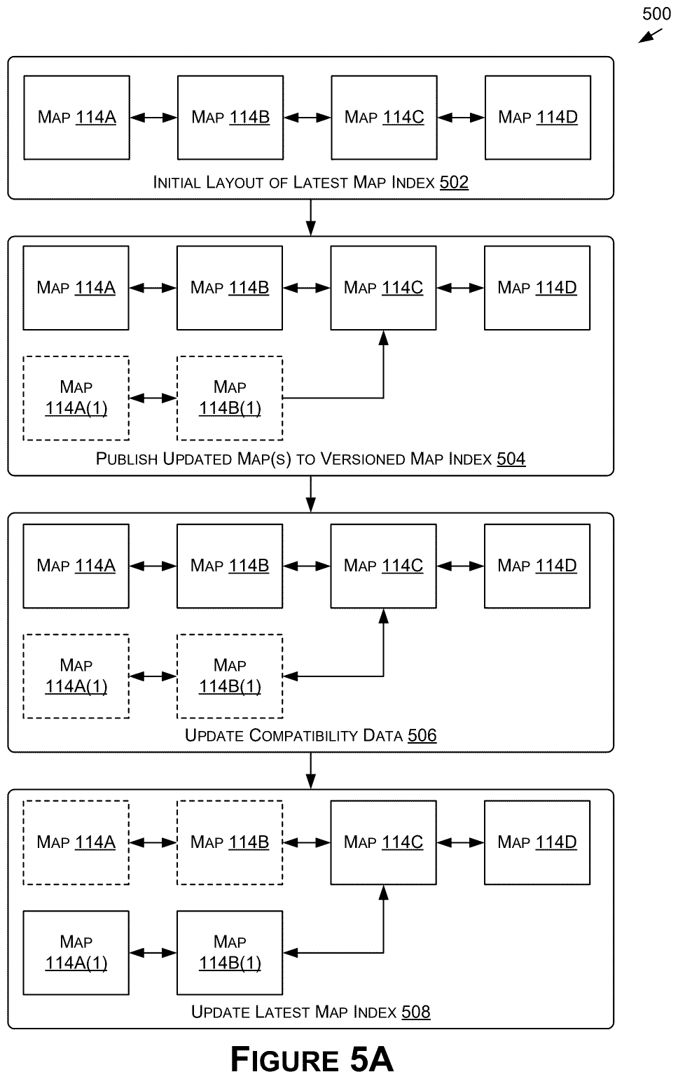

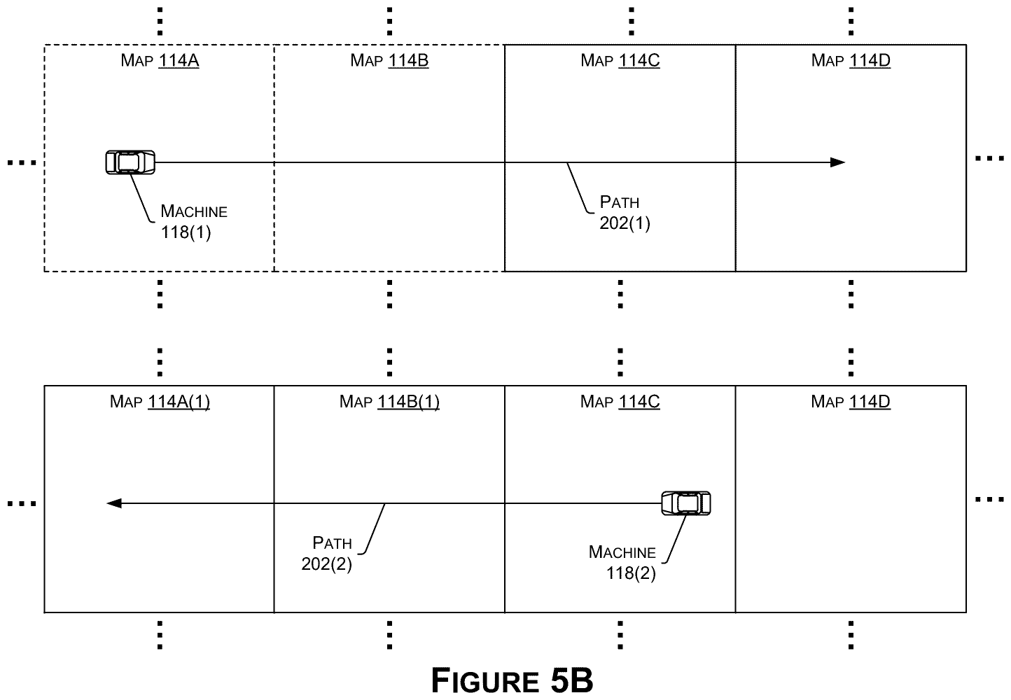

For example, FIG. 5A is a pictorial flow diagram illustrating an example process 500 for updating one or more maps corresponding to one or more regions of an environment, in accordance with some embodiments of the present disclosure. In some examples, the process 500 may be performed in whole or in part by the update component(s) 108.

The illustration 502 of FIG. 5A represents an example of an initial layout of the latest map index 112 prior to one or more new versions of one or more maps being generated. For instance, the illustration 502 shows the latest map index 112 may include a first map 114A, a second map 114B, a third map 114C, and a fourth map 114D. In the illustration 502, the first map 114A is compatible with the second map 114B, the second map 114B is compatible with the first map 114A and the third map 114C, the third map 114C is compatible with the second map 114B and the fourth map 114D, and the fourth map 114D is compatible with the third map 114C.

In the illustration 504, one or more updated maps are published to the versioned map index 110. In the example of FIG. 5, the maps currently stored/published in the latest map index 112 are shown in solid lines, while the maps stored/published in only the versioned map index 110 are shown in broken lines. For instance, the updated first map 114A(1) and the updated second map 114B(1), which correspond to updated versions of the first map 114A and the second map 114B, respectively, are shown in broken lines as the update component(s) 108 may first publish the updated first map 114A(1) and the updated second map 114B(1) to the versioned map index 110 first.

Additionally, and still with reference to the illustration 504, compatibility data may be published in the versioned index 110 in association with the updated first map 114A(1) and the updated second map 114B(1). For instance, the compatibility data may indicate, as shown in the illustration 504, that the updated first map 114A(1) is compatible with the updated second map 114B(1) but not the second map 114B, and that updated second map 114B(1) is compatible with the updated first map 114A(1) and the third map 114C, but not the first map 114A.

In the illustration 506, the update component(s) 108 may then cause the compatibility data for at least the third map 114C to be updated. For instance, the update component(s) 108 may update the compatibility data for the third map 114C to indicate, as shown, that the third map 114C is compatible with both the second map 114B and the updated second map 114B(1), in addition to the fourth map 114D.

Then, in the illustration 508, the update component(s) 108 may update the latest map index 112 to include the updated first map 114A(1) and the updated second map 114B(1), as shown in solid lines in the illustration 508. That is, the update component(s) 108 may update the latest map index 112 to indicate that the updated first map 114A(1) and the updated second map 114B(1) are the latest versions of the first map and the second map, respectively. Additionally, the update component(s) 108 may remove the first map 114A and the second map 114B from the latest map index 112, however, the first map 114A and the second map 114B may remain stored in the versioned map index 110, as shown by the broken lines in the illustration 508. In this way, machines that rely on the maps may still use the previous versions of the maps that are still valid and update their map versions when they are ready to do so.

For instance, FIG. 5B is an illustration of different versions of maps being provided to machines based on different factors, in accordance with some embodiments of the present disclosure. The map versions illustrated in FIG. 5B may correspond to the maps of the illustration 508 of FIG. 5A. In FIG. 5B, a first machine 118(1) may use the first map 114A, the second map 114B, the third map 114C, and the fourth map 114D to navigate the environment even though the first map 114A and the second map 114B are not the latest versions. In some examples, the first machine 118(1) may have begun traversing the first path 202(1) and obtained the maps 114A-114D before the compatibility data for the maps 114A-114D were updated and/or before the updated first map 114A(1) and the updated second map 114B(1) were published to the latest map index 112. In contrast, the second machine 118(2) may use the updated first map 114A(a), the updated second map 114B(1), the third map 114C, and the fourth map 114D to navigate the environment. In some examples, the second machine 118(2) may have begun traversing the second path 202(2) and obtained the updated maps after all the compatibility data for the maps 114A(1)-114D were updated and/or after the updated first map 114A(1) and the updated second map 114B(1) were published to the latest map index 112.

Now referring back to the example of FIG. 1, the process 100 may include the map system 102 providing one or more of the map(s) 114 to the machine(s) 118 based at least on receiving the map request(s) 120 from the machine(s) 118. In some examples, the map(s) 114 provided to the machine(s) 118 may include maps from the latest map index 112 and/or maps from the versioned map index 110. That is, the map system 102 may use the compatibility data 116 to provide the machine(s) 118 with the map(s) 114 that may be compatible with one another, regardless of whether those map(s) 114 include the latest versions.

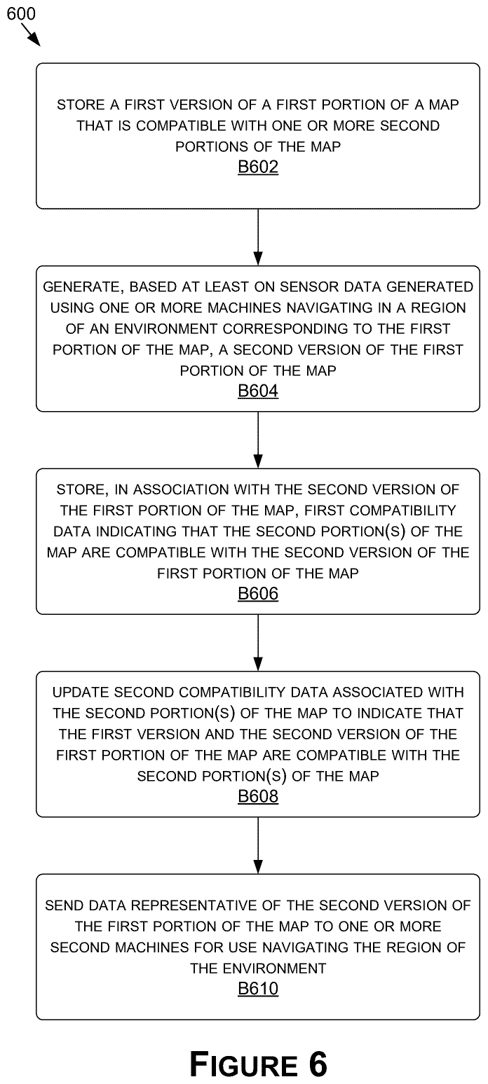

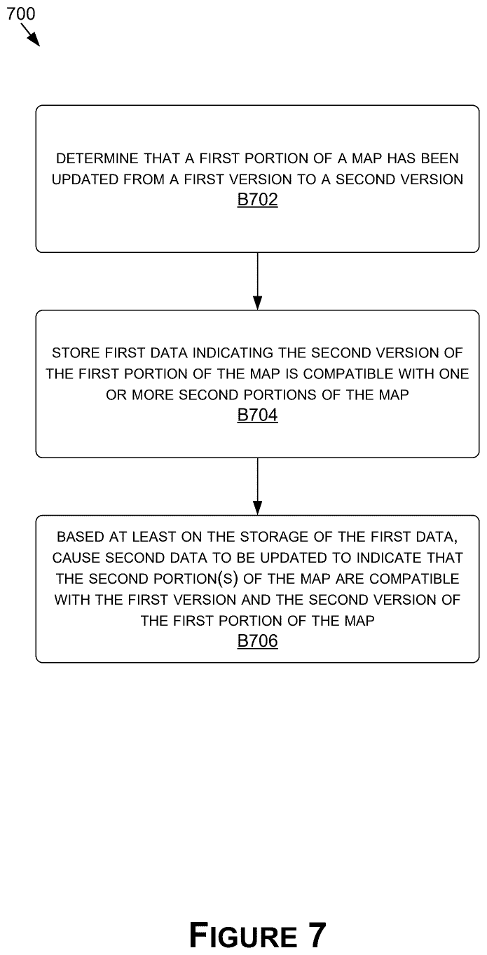

Now referring to FIGS. 6 and 7, each block of methods 600 and 700, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 600 and 700 are described, by way of example, with respect to FIG. 1. However, these methods may additionally or alternatively be executed by any one system, or any combination of systems, including, but not limited to, those described herein.

FIG. 6 is a flow diagram illustrating an example method 600 for updating one or more portions of a map used for navigating an environment, in accordance with some embodiments of the present disclosure. The method 600, at block B602, may include storing a first version of a first portion of a map that is compatible with one or more second portions of the map. For instance, the update component(s) 108 may store the first version of the first portion of the map in the versioned map index 110 and/or the latest map index 112. Additionally, the update component(s) 108 may store compatibility data 116 that indicates the first version of the first portion of the map is compatible with the second portion(s) of the map.

The method 600, at block B604, may include generating, based at least on sensor data generated using one or more machines navigating in a region of an environment corresponding to the first portion of the map, a second version of the first portion of the map. For instance, the map generator(s) 104 may generate the second version of the first portion of the map based at least on the sensor data generated using the machine(s) 118 navigating in the region of the environment corresponding to the first portion of the map. In some examples, the second version of the first portion of the map may include one or more updates from the first version, such as updated road locations, updated lane lines, updated object locations, etc. Additional detail relating to generating maps based on data generated using machines operating in an environment is described in U.S. patent application Ser. No. 18/538,558, which is incorporated herein by reference in its entirety and for all purposes.

The method 600, at block B606, may include storing, in association with the second version of the first portion of the map, first compatibility data indicating that the second portion(s) of the map are compatible with the second version of the first portion of the map. For instance, the update component(s) 108 may store the first compatibility data indicating that the second portion(s) of the map are compatible with the second version of the first portion of the map. In some examples, the update component(s) 108 may store the first compatibility data in the versioned map index 110 in association with the second version of the first portion of the map.

The method 600, at block B608, may include updating second compatibility data associated with the second portion(s) of the map to indicate that the first version and the second version of the first portion of the map are compatible with the second portion(s) of the map. For instance, the update component(s) 108 may update the second compatibility data associated with the second portion(s) of the map to indicate that the first version and the second version of the first portion of the map are compatible with the second portion(s) of the map. In some examples, the second compatibility data may be updated based at least on (e.g., partially responsive to) the storage of the first compatibility data. In some examples, the second compatibility data may be updated in one or more of the versioned map index 110 and/or the latest map index 112.

The method 600, at block B610, may include sending data representative of the second version of the first portion of the map to one or more second machines for use navigating the region of the environment. For instance, the map system 102 may send the map(s) 114 to the machine(s) 118. The map(s) 114 may include the data representative of the second version of the first portion of the map to one or more second machines for use navigating the region of the environment. The second version of the first portion of the map may correspond to the latest version of the map stored in the latest map index 112.

FIG. 7 is a flow diagram illustrating an example method 700 for storing and/or updating map compatibility data in association with updating one or more portions of a map, in accordance with some embodiments of the present disclosure. The method 700, at block B702, may include determining that a first portion of a map has been updated from a first version to a second version. For instance, the update component(s) 108 may determine that the first portion of the map (e.g., a map of the map(s) 114) has been updated from the first version to the second version. In some examples, the second version may include one or more updated features compared to the first version, such as updated road locations, updated lane lines, updated objects, updated traffic signs, updated drivable surfaces, etc. In some examples, the second version of the first portion of the map may be generated by the map generator(s) 104 of the map system 102.

The method 700, at block B704, may include storing first data indicating the second version of the first portion of the map is compatible with one or more second portions of the map. For instance, the update component(s) 108 may store the first data indicating that the second version of the first portion of the map is compatible with the second portion(s) of the map. In some examples, the update component(s) 108 may store the first data in the versioned map index 110 in association with the second version of the first portion of the map. For instance, the first data may correspond to compatibility data 116 associated with the second version of the first portion of the map.

The method 700, at block B706, may include, based at least on the storage of the first data, causing second data to be updated to indicate that the second portion(s) of the map are compatible with the first version and the second version of the first portion of the map. For instance, the update component(s) 108 may cause the second data to be updated to indicate that the second portion(s) of the map are compatible with at least one of the first version and/or the second version of the first portion of the map. In some examples, the second data may be updated based at least on (e.g., partially responsive to) the storage of the first data. In some examples, the second data may correspond to compatibility data 116 for the second portion(s) of the map, and the second compatibility data may be updated in one or more of the versioned map index 110 and/or the latest map index 112.

### Example Autonomous Vehicle

FIG. 8A is an illustration of an example autonomous vehicle 800, in accordance with some embodiments of the present disclosure. The autonomous vehicle 800 (alternatively referred to herein as the “vehicle 800”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 800 may be capable of functionality in accordance with one or more of Level 3-Level 5 of the autonomous driving levels. The vehicle 800 may be capable of functionality in accordance with one or more of Level 1-Level 5 of the autonomous driving levels. For example, the vehicle 800 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 800 or other machine, such as being fully autonomous, being highly autonomous, being conditionally autonomous, being partially autonomous, providing assistive autonomy, being semi-autonomous, being primarily autonomous, or other designation.

The vehicle 800 may include components such as a chassis, a vehicle body, wheels (e.g., 2, 4, 6, 8, 18, etc.), tires, axles, and other components of a vehicle. The vehicle 800 may include a propulsion system 850, such as an internal combustion engine, hybrid electric power plant, an all-electric engine, and/or another propulsion system type. The propulsion system 850 may be connected to a drive train of the vehicle 800, which may include a transmission, to enable the propulsion of the vehicle 800. The propulsion system 850 may be controlled in response to receiving signals from the throttle/accelerator 852.

A steering system 854, which may include a steering wheel, may be used to steer the vehicle 800 (e.g., along a desired path or route) when the propulsion system 850 is operating (e.g., when the vehicle is in motion). The steering system 854 may receive signals from a steering actuator 856. The steering wheel may be optional for full automation (Level 5) functionality.

The brake sensor system 846 may be used to operate the vehicle brakes in response to receiving signals from the brake actuators 848 and/or brake sensors.

Controller(s) 836, which may include one or more system on chips (SoCs) 804 (FIG. 8C) and/or GPU(s), may provide signals (e.g., representative of commands) to one or more components and/or systems of the vehicle 800. For example, the controller(s) may send signals to operate the vehicle brakes via one or more brake actuators 848, to operate the steering system 854 via one or more steering actuators 856, to operate the propulsion system 850 via one or more throttle/accelerators 852. The controller(s) 836 may include one or more onboard (e.g., integrated) computing devices (e.g., supercomputers) that process sensor signals, and output operation commands (e.g., signals representing commands) to enable autonomous driving and/or to assist a human driver in driving the vehicle 800. The controller(s) 836 may include a first controller 836 for autonomous driving functions, a second controller 836 for functional safety functions, a third controller 836 for artificial intelligence functionality (e.g., computer vision), a fourth controller 836 for infotainment functionality, a fifth controller 836 for redundancy in emergency conditions, and/or other controllers. In some examples, a single controller 836 may handle two or more of the above functionalities, two or more controllers 836 may handle a single functionality, and/or any combination thereof.

The controller(s) 836 may provide the signals for controlling one or more components and/or systems of the vehicle 800 in response to sensor data received from one or more sensors (e.g., sensor inputs). The sensor data may be received from, for example and without limitation, global navigation satellite systems (“GNSS”) sensor(s) 858 (e.g., Global Positioning System sensor(s)), RADAR sensor(s) 860, ultrasonic sensor(s) 862, LIDAR sensor(s) 864, inertial measurement unit (IMU) sensor(s) 866 (e.g., accelerometer(s), gyroscope(s), magnetic compass(es), magnetometer(s), etc.), microphone(s) 896, stereo camera(s) 868, wide-view camera(s) 870 (e.g., fisheye cameras), infrared camera(s) 872, surround camera(s) 874 (e.g., 360 degree cameras), long-range and/or mid-range camera(s) 898, speed sensor(s) 844 (e.g., for measuring the speed of the vehicle 800), vibration sensor(s) 842, steering sensor(s) 840, brake sensor(s) (e.g., as part of the brake sensor system 846), and/or other sensor types.

One or more of the controller(s) 836 may receive inputs (e.g., represented by input data) from an instrument cluster 832 of the vehicle 800 and provide outputs (e.g., represented by output data, display data, etc.) via a human-machine interface (HMI) display 834, an audible annunciator, a loudspeaker, and/or via other components of the vehicle 800. The outputs may include information such as vehicle velocity, speed, time, map data (e.g., the High Definition (“HD”) map 822 of FIG. 8C), location data (e.g., the vehicle's 800 location, such as on a map), direction, location of other vehicles (e.g., an occupancy grid), information about objects and status of objects as perceived by the controller(s) 836, etc. For example, the HMI display 834 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 800 further includes a network interface 824 which may use one or more wireless antenna(s) 826 and/or modem(s) to communicate over one or more networks. For example, the network interface 824 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 826 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 8B is an example of camera locations and fields of view for the example autonomous vehicle 800 of FIG. 8A, in accordance with some embodiments of the present disclosure. The cameras and respective fields of view are one example embodiment and are not intended to be limiting. For example, additional and/or alternative cameras may be included and/or the cameras may be located at different locations on the vehicle 800.

The camera types for the cameras may include, but are not limited to, digital cameras that may be adapted for use with the components and/or systems of the vehicle 800. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 800 (e.g., front-facing cameras) may be used for surround view, to help identify forward facing paths and obstacles, as well aid in, with the help of one or more controllers 836 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 870 that may be used to perceive objects coming into view from the periphery (e.g., pedestrians, crossing traffic or bicycles). Although only one wide-view camera is illustrated in FIG. 8B, there may be any number (including zero) of wide-view cameras 870 on the vehicle 800. In addition, any number of long-range camera(s) 898 (e.g., a long-view stereo camera pair) may be used for depth-based object detection, especially for objects for which a neural network has not yet been trained. The long-range camera(s) 898 may also be used for object detection and classification, as well as basic object tracking.

Any number of stereo cameras 868 may also be included in a front-facing configuration. In at least one embodiment, one or more of stereo camera(s) 868 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 868 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 868 may be used in addition to, or alternatively from, those described herein.

Cameras with a field of view that include portions of the environment to the side of the vehicle 800 (e.g., side-view cameras) may be used for surround view, providing information used to create and update the occupancy grid, as well as to generate side impact collision warnings. For example, surround camera(s) 874 (e.g., four surround cameras 874 as illustrated in FIG. 8B) may be positioned to on the vehicle 800. The surround camera(s) 874 may include wide-view camera(s) 870, fisheye camera(s), 360 degree camera(s), and/or the like. Four example, four fisheye cameras may be positioned on the vehicle's front, rear, and sides. In an alternative arrangement, the vehicle may use three surround camera(s) 874 (e.g., left, right, and rear), and may leverage one or more other camera(s) (e.g., a forward-facing camera) as a fourth surround view camera.

Cameras with a field of view that include portions of the environment to the rear of the vehicle 800 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 898, stereo camera(s) 868), infrared camera(s) 872, etc.), as described herein.

FIG. 8C is a block diagram of an example system architecture for the example autonomous vehicle 800 of FIG. 8A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 800 in FIG. 8C are illustrated as being connected via bus 802. The bus 802 may include a Controller Area Network (CAN) data interface (alternatively referred to herein as a “CAN bus”). A CAN may be a network inside the vehicle 800 used to aid in control of various features and functionality of the vehicle 800, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 802 is described herein as being a CAN bus, this is not intended to be limiting. For example, in addition to, or alternatively from, the CAN bus, FlexRay and/or Ethernet may be used. Additionally, although a single line is used to represent the bus 802, this is not intended to be limiting. For example, there may be any number of busses 802, which may include one or more CAN busses, one or more FlexRay busses, one or more Ethernet busses, and/or one or more other types of busses using a different protocol. In some examples, two or more busses 802 may be used to perform different functions, and/or may be used for redundancy. For example, a first bus 802 may be used for collision avoidance functionality and a second bus 802 may be used for actuation control. In any example, each bus 802 may communicate with any of the components of the vehicle 800, and two or more busses 802 may communicate with the same components. In some examples, each SoC 804, each controller 836, and/or each computer within the vehicle may have access to the same input data (e.g., inputs from sensors of the vehicle 800), and may be connected to a common bus, such the CAN bus.

The vehicle 800 may include one or more controller(s) 836, such as those described herein with respect to FIG. 8A. The controller(s) 836 may be used for a variety of functions. The controller(s) 836 may be coupled to any of the various other components and systems of the vehicle 800, and may be used for control of the vehicle 800, artificial intelligence of the vehicle 800, infotainment for the vehicle 800, and/or the like.

The vehicle 800 may include a system(s) on a chip (SoC) 804. The SoC 804 may include CPU(s) 806, GPU(s) 808, processor(s) 810, cache(s) 812, accelerator(s) 814, data store(s) 816, and/or other components and features not illustrated. The SoC(s) 804 may be used to control the vehicle 800 in a variety of platforms and systems. For example, the SoC(s) 804 may be combined in a system (e.g., the system of the vehicle 800) with an HD map 822 which may obtain map refreshes and/or updates via a network interface 824 from one or more servers (e.g., server(s) 878 of FIG. 8D).

The CPU(s) 806 may include a CPU cluster or CPU complex (alternatively referred to herein as a “CCPLEX”). The CPU(s) 806 may include multiple cores and/or L2 caches. For example, in some embodiments, the CPU(s) 806 may include eight cores in a coherent multi-processor configuration. In some embodiments, the CPU(s) 806 may include four dual-core clusters where each cluster has a dedicated L2 cache (e.g., a 2 MB L2 cache). The CPU(s) 806 (e.g., the CCPLEX) may be configured to support simultaneous cluster operation enabling any combination of the clusters of the CPU(s) 806 to be active at any given time.

The CPU(s) 806 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 806 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 808 may include an integrated GPU (alternatively referred to herein as an “iGPU”). The GPU(s) 808 may be programmable and may be efficient for parallel workloads. The GPU(s) 808, in some examples, may use an enhanced tensor instruction set. The GPU(s) 808 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 808 may include at least eight streaming microprocessors. The GPU(s) 808 may use compute application programming interface(s) (API(s)). In addition, the GPU(s) 808 may use one or more parallel computing platforms and/or programming models (e.g., NVIDIA's CUDA).

The GPU(s) 808 may be power-optimized for best performance in automotive and embedded use cases. For example, the GPU(s) 808 may be fabricated on a Fin field-effect transistor (FinFET). However, this is not intended to be limiting and the GPU(s) 808 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 808 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 808 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 808 to access the CPU(s) 806 page tables directly. In such examples, when the GPU(s) 808 memory management unit (MMU) experiences a miss, an address translation request may be transmitted to the CPU(s) 806. In response, the CPU(s) 806 may look in its page tables for the virtual-to-physical mapping for the address and transmits the translation back to the GPU(s) 808. As such, unified memory technology may allow a single unified virtual address space for memory of both the CPU(s) 806 and the GPU(s) 808, thereby simplifying the GPU(s) 808 programming and porting of applications to the GPU(s) 808.

In addition, the GPU(s) 808 may include an access counter that may keep track of the frequency of access of the GPU(s) 808 to memory of other processors. The access counter may help ensure that memory pages are moved to the physical memory of the processor that is accessing the pages most frequently.

The SoC(s) 804 may include any number of cache(s) 812, including those described herein. For example, the cache(s) 812 may include an L3 cache that is available to both the CPU(s) 806 and the GPU(s) 808 (e.g., that is connected both the CPU(s) 806 and the GPU(s) 808). The cache(s) 812 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 804 may include an arithmetic logic unit(s) (ALU(s)) which may be leveraged in performing processing with respect to any of the variety of tasks or operations of the vehicle 800—such as processing DNNs. In addition, the SoC(s) 804 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 806 and/or GPU(s) 808.

The SoC(s) 804 may include one or more accelerators 814 (e.g., hardware accelerators, software accelerators, or a combination thereof). For example, the SoC(s) 804 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 808 and to off-load some of the tasks of the GPU(s) 808 (e.g., to free up more cycles of the GPU(s) 808 for performing other tasks). As an example, the accelerator(s) 814 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 814 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 808, and by using an inference accelerator, for example, a designer may target either the DLA(s) or the GPU(s) 808 for any function. For example, the designer may focus processing of CNNs and floating point operations on the DLA(s) and leave other functions to the GPU(s) 808 and/or other accelerator(s) 814.

The accelerator(s) 814 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 806. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 814 (e.g., the hardware acceleration cluster) may include a computer vision network on-chip and SRAM, for providing a high-bandwidth, low latency SRAM for the accelerator(s) 814. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 804 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 814 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 866 output that correlates with the vehicle 800 orientation, distance, 3D location estimates of the object obtained from the neural network and/or other sensors (e.g., LIDAR sensor(s) 864 or RADAR sensor(s) 860), among others.

The SoC(s) 804 may include data store(s) 816 (e.g., memory). The data store(s) 816 may be on-chip memory of the SoC(s) 804, which may store neural networks to be executed on the GPU and/or the DLA. In some examples, the data store(s) 816 may be large enough in capacity to store multiple instances of neural networks for redundancy and safety. The data store(s) 812 may comprise L2 or L3 cache(s) 812. Reference to the data store(s) 816 may include reference to the memory associated with the PVA, DLA, and/or other accelerator(s) 814, as described herein.

The SoC(s) 804 may include one or more processor(s) 810 (e.g., embedded processors). The processor(s) 810 may include a boot and power management processor that may be a dedicated processor and subsystem to handle boot power and management functions and related security enforcement. The boot and power management processor may be a part of the SoC(s) 804 boot sequence and may provide runtime power management services. The boot power and management processor may provide clock and voltage programming, assistance in system low power state transitions, management of SoC(s) 804 thermals and temperature sensors, and/or management of the SoC(s) 804 power states. Each temperature sensor may be implemented as a ring-oscillator whose output frequency is proportional to temperature, and the SoC(s) 804 may use the ring-oscillators to detect temperatures of the CPU(s) 806, GPU(s) 808, and/or accelerator(s) 814. If temperatures are determined to exceed a threshold, the boot and power management processor may enter a temperature fault routine and put the SoC(s) 804 into a lower power state and/or put the vehicle 800 into a chauffeur to safe stop mode (e.g., bring the vehicle 800 to a safe stop).

The processor(s) 810 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 810 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 810 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 810 may further include a real-time camera engine that may include a dedicated processor subsystem for handling real-time camera management.

The processor(s) 810 may further include a high-dynamic range signal processor that may include an image signal processor that is a hardware engine that is part of the camera processing pipeline.

The processor(s) 810 may include a video image compositor that may be a processing block (e.g., implemented on a microprocessor) that implements video post-processing functions needed by a video playback application to produce the final image for the player window. The video image compositor may perform lens distortion correction on wide-view camera(s) 870, surround camera(s) 874, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 808 is not required to continuously render new surfaces. Even when the GPU(s) 808 is powered on and active doing 3D rendering, the video image compositor may be used to offload the GPU(s) 808 to improve performance and responsiveness.

The SoC(s) 804 may further include a mobile industry processor interface (MIPI) camera serial interface for receiving video and input from cameras, a high-speed interface, and/or a video input block that may be used for camera and related pixel input functions. The SoC(s) 804 may further include an input/output controller(s) that may be controlled by software and may be used for receiving I/O signals that are uncommitted to a specific role.

The SoC(s) 804 may further include a broad range of peripheral interfaces to enable communication with peripherals, audio codecs, power management, and/or other devices. The SoC(s) 804 may be used to process data from cameras (e.g., connected over Gigabit Multimedia Serial Link and Ethernet), sensors (e.g., LIDAR sensor(s) 864, RADAR sensor(s) 860, etc. that may be connected over Ethernet), data from bus 802 (e.g., speed of vehicle 800, steering wheel position, etc.), data from GNSS sensor(s) 858 (e.g., connected over Ethernet or CAN bus). The SoC(s) 804 may further include dedicated high-performance mass storage controllers that may include their own DMA engines, and that may be used to free the CPU(s) 806 from routine data management tasks.

The SoC(s) 804 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 804 may be faster, more reliable, and even more energy-efficient and space-efficient than conventional systems. For example, the accelerator(s) 814, when combined with the CPU(s) 806, the GPU(s) 808, and the data store(s) 816, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 820) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 808.

In some examples, a CNN for facial recognition and vehicle owner identification may use data from camera sensors to identify the presence of an authorized driver and/or owner of the vehicle 800. The always on sensor processing engine may be used to unlock the vehicle when the owner approaches the driver door and turn on the lights, and, in security mode, to disable the vehicle when the owner leaves the vehicle. In this way, the SoC(s) 804 provide for security against theft and/or carjacking.

In another example, a CNN for emergency vehicle detection and identification may use data from microphones 896 to detect and identify emergency vehicle sirens. In contrast to conventional systems, that use general classifiers to detect sirens and manually extract features, the SoC(s) 804 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 858. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 862, until the emergency vehicle(s) passes.

The vehicle may include a CPU(s) 818 (e.g., discrete CPU(s), or dCPU(s)), that may be coupled to the SoC(s) 804 via a high-speed interconnect (e.g., PCIe). The CPU(s) 818 may include an X86 processor, for example. The CPU(s) 818 may be used to perform any of a variety of functions, including arbitrating potentially inconsistent results between ADAS sensors and the SoC(s) 804, and/or monitoring the status and health of the controller(s) 836 and/or infotainment SoC 830, for example.

The vehicle 800 may include a GPU(s) 820 (e.g., discrete GPU(s), or dGPU(s)), that may be coupled to the SoC(s) 804 via a high-speed interconnect (e.g., NVIDIA's NVLINK). The GPU(s) 820 may provide additional artificial intelligence functionality, such as by executing redundant and/or different neural networks, and may be used to train and/or update neural networks based on input (e.g., sensor data) from sensors of the vehicle 800.

The vehicle 800 may further include the network interface 824 which may include one or more wireless antennas 826 (e.g., one or more wireless antennas for different communication protocols, such as a cellular antenna, a Bluetooth antenna, etc.). The network interface 824 may be used to enable wireless connectivity over the Internet with the cloud (e.g., with the server(s) 878 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 800 information about vehicles in proximity to the vehicle 800 (e.g., vehicles in front of, on the side of, and/or behind the vehicle 800). This functionality may be part of a cooperative adaptive cruise control functionality of the vehicle 800.

The network interface 824 may include a SoC that provides modulation and demodulation functionality and enables the controller(s) 836 to communicate over wireless networks. The network interface 824 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 800 may further include data store(s) 828 which may include off-chip (e.g., off the SoC(s) 804) storage. The data store(s) 828 may include one or more storage elements including RAM, SRAM, DRAM, VRAM, Flash, hard disks, and/or other components and/or devices that may store at least one bit of data.

The vehicle 800 may further include GNSS sensor(s) 858. The GNSS sensor(s) 858 (e.g., GPS, assisted GPS sensors, differential GPS (DGPS) sensors, etc.), to assist in mapping, perception, occupancy grid generation, and/or path planning functions. Any number of GNSS sensor(s) 858 may be used, including, for example and without limitation, a GPS using a USB connector with an Ethernet to Serial (RS-232) bridge.

The vehicle 800 may further include RADAR sensor(s) 860. The RADAR sensor(s) 860 may be used by the vehicle 800 for long-range vehicle detection, even in darkness and/or severe weather conditions. RADAR functional safety levels may be ASIL B. The RADAR sensor(s) 860 may use the CAN and/or the bus 802 (e.g., to transmit data generated by the RADAR sensor(s) 860) for control and to access object tracking data, with access to Ethernet to access raw data in some examples. A wide variety of RADAR sensor types may be used. For example, and without limitation, the RADAR sensor(s) 860 may be suitable for front, rear, and side RADAR use. In some examples, Pulse Doppler RADAR sensor(s) are used.

The RADAR sensor(s) 860 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 860 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 800 surroundings at higher speeds with minimal interference from traffic in adjacent lanes. The other two antennae may expand the field of view, making it possible to quickly detect vehicles entering or leaving the vehicle's 800 lane.

Mid-range RADAR systems may include, as an example, a range of up to 860 m (front) or 80 m (rear), and a field of view of up to 42 degrees (front) or 850 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 800 may further include ultrasonic sensor(s) 862. The ultrasonic sensor(s) 862, which may be positioned at the front, back, and/or the sides of the vehicle 800, may be used for park assist and/or to create and update an occupancy grid. A wide variety of ultrasonic sensor(s) 862 may be used, and different ultrasonic sensor(s) 862 may be used for different ranges of detection (e.g., 2.5 m, 4 m). The ultrasonic sensor(s) 862 may operate at functional safety levels of ASIL B.

The vehicle 800 may include LIDAR sensor(s) 864. The LIDAR sensor(s) 864 may be used for object and pedestrian detection, emergency braking, collision avoidance, and/or other functions. The LIDAR sensor(s) 864 may be functional safety level ASIL B. In some examples, the vehicle 800 may include multiple LIDAR sensors 864 (e.g., two, four, six, etc.) that may use Ethernet (e.g., to provide data to a Gigabit Ethernet switch).

In some examples, the LIDAR sensor(s) 864 may be capable of providing a list of objects and their distances for a 360-degree field of view. Commercially available LIDAR sensor(s) 864 may have an advertised range of approximately 800 m, with an accuracy of 2 cm-3 cm, and with support for a 800 Mbps Ethernet connection, for example. In some examples, one or more non-protruding LIDAR sensors 864 may be used. In such examples, the LIDAR sensor(s) 864 may be implemented as a small device that may be embedded into the front, rear, sides, and/or corners of the vehicle 800. The LIDAR sensor(s) 864, in such examples, may provide up to a 120-degree horizontal and 35-degree vertical field-of-view, with a 200 m range even for low-reflectivity objects. Front-mounted LIDAR sensor(s) 864 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 800. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 864 may be less susceptible to motion blur, vibration, and/or shock.

The vehicle may further include IMU sensor(s) 866. The IMU sensor(s) 866 may be located at a center of the rear axle of the vehicle 800, in some examples. The IMU sensor(s) 866 may include, for example and without limitation, an accelerometer(s), a magnetometer(s), a gyroscope(s), a magnetic compass(es), and/or other sensor types. In some examples, such as in six-axis applications, the IMU sensor(s) 866 may include accelerometers and gyroscopes, while in nine-axis applications, the IMU sensor(s) 866 may include accelerometers, gyroscopes, and magnetometers.

In some embodiments, the IMU sensor(s) 866 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 866 may enable the vehicle 800 to estimate heading without requiring input from a magnetic sensor by directly observing and correlating the changes in velocity from GPS to the IMU sensor(s) 866. In some examples, the IMU sensor(s) 866 and the GNSS sensor(s) 858 may be combined in a single integrated unit.

The vehicle may include microphone(s) 896 placed in and/or around the vehicle 800. The microphone(s) 896 may be used for emergency vehicle detection and identification, among other things.

The vehicle may further include any number of camera types, including stereo camera(s) 868, wide-view camera(s) 870, infrared camera(s) 872, surround camera(s) 874, long-range and/or mid-range camera(s) 898, and/or other camera types. The cameras may be used to capture image data around an entire periphery of the vehicle 800. The types of cameras used depends on the embodiments and requirements for the vehicle 800, and any combination of camera types may be used to provide the necessary coverage around the vehicle 800. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 8A and FIG. 8B.

The vehicle 800 may further include vibration sensor(s) 842. The vibration sensor(s) 842 may measure vibrations of components of the vehicle, such as the axle(s). For example, changes in vibrations may indicate a change in road surfaces. In another example, when two or more vibration sensors 842 are used, the differences between the vibrations may be used to determine friction or slippage of the road surface (e.g., when the difference in vibration is between a power-driven axle and a freely rotating axle).

The vehicle 800 may include an ADAS system 838. The ADAS system 838 may include SoC, in some examples. The ADAS system 838 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 860, LIDAR sensor(s) 864, and/or a camera(s). The ACC systems may include longitudinal ACC and/or lateral ACC. Longitudinal ACC monitors and controls the distance to the vehicle immediately ahead of the vehicle 800 and automatically adjust the vehicle speed to maintain a safe distance from vehicles ahead. Lateral ACC performs distance keeping, and advises the vehicle 800 to change lanes when necessary. Lateral ACC is related to other ADAS applications such as LCA and CWS.

CACC uses information from other vehicles that may be received via the network interface 824 and/or the wireless antenna(s) 826 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 800), while the I2V communication concept provides information about traffic further ahead. CACC systems may include either or both I2V and V2V information sources. Given the information of the vehicles ahead of the vehicle 800, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 860, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 860, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 800 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 800 if the vehicle 800 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 860, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 800 is backing up. Some RCTW systems include AEB to ensure that the vehicle brakes are applied to avoid a crash. RCTW systems may use one or more rear-facing RADAR sensor(s) 860, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 800, the vehicle 800 itself must, in the case of conflicting results, decide whether to heed the result from a primary computer or a secondary computer (e.g., a first controller 836 or a second controller 836). For example, in some embodiments, the ADAS system 838 may be a backup and/or secondary computer for providing perception information to a backup computer rationality module. The backup computer rationality monitor may run a redundant diverse software on hardware components to detect faults in perception and dynamic driving tasks. Outputs from the ADAS system 838 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 804.

In other examples, ADAS system 838 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 838 may be fed into the primary computer's perception block and/or the primary computer's dynamic driving task block. For example, if the ADAS system 838 indicates a forward crash warning due to an object immediately ahead, the perception block may use this information when identifying objects. In other examples, the secondary computer may have its own neural network which is trained and thus reduces the risk of false positives, as described herein.

The vehicle 800 may further include the infotainment SoC 830 (e.g., an in-vehicle infotainment system (IVI)). Although illustrated and described as a SoC, the infotainment system may not be a SoC, and may include two or more discrete components. The infotainment SoC 830 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 800. For example, the infotainment SoC 830 may radios, disk players, navigation systems, video players, USB and Bluetooth connectivity, carputers, in-car entertainment, Wi-Fi, steering wheel audio controls, hands free voice control, a heads-up display (HUD), an HMI display 834, a telematics device, a control panel (e.g., for controlling and/or interacting with various components, features, and/or systems), and/or other components. The infotainment SoC 830 may further be used to provide information (e.g., visual and/or audible) to a user(s) of the vehicle, such as information from the ADAS system 838, autonomous driving information such as planned vehicle maneuvers, trajectories, surrounding environment information (e.g., intersection information, vehicle information, road information, etc.), and/or other information.

The infotainment SoC 830 may include GPU functionality. The infotainment SoC 830 may communicate over the bus 802 (e.g., CAN bus, Ethernet, etc.) with other devices, systems, and/or components of the vehicle 800. In some examples, the infotainment SoC 830 may be coupled to a supervisory MCU such that the GPU of the infotainment system may perform some self-driving functions in the event that the primary controller(s) 836 (e.g., the primary and/or backup computers of the vehicle 800) fail. In such an example, the infotainment SoC 830 may put the vehicle 800 into a chauffeur to safe stop mode, as described herein.

The vehicle 800 may further include an instrument cluster 832 (e.g., a digital dash, an electronic instrument cluster, a digital instrument panel, etc.). The instrument cluster 832 may include a controller and/or supercomputer (e.g., a discrete controller or supercomputer). The instrument cluster 832 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 830 and the instrument cluster 832. In other words, the instrument cluster 832 may be included as part of the infotainment SoC 830, or vice versa.

FIG. 8D is a system diagram for communication between cloud-based server(s) and the example autonomous vehicle 800 of FIG. 8A, in accordance with some embodiments of the present disclosure. The system 876 may include server(s) 878, network(s) 890, and vehicles, including the vehicle 800. The server(s) 878 may include a plurality of GPUs 884(A)-884(H) (collectively referred to herein as GPUs 884), PCIe switches 882(A)-882(H) (collectively referred to herein as PCIe switches 882), and/or CPUs 880(A)-880(B) (collectively referred to herein as CPUs 880). The GPUs 884, the CPUs 880, and the PCIe switches may be interconnected with high-speed interconnects such as, for example and without limitation, NVLink interfaces 888 developed by NVIDIA and/or PCIe connections 886. In some examples, the GPUs 884 are connected via NVLink and/or NVSwitch SoC and the GPUs 884 and the PCIe switches 882 are connected via PCIe interconnects. Although eight GPUs 884, two CPUs 880, and two PCIe switches are illustrated, this is not intended to be limiting. Depending on the embodiment, each of the server(s) 878 may include any number of GPUs 884, CPUs 880, and/or PCIe switches. For example, the server(s) 878 may each include eight, sixteen, thirty-two, and/or more GPUs 884.

The server(s) 878 may receive, over the network(s) 890 and from the vehicles, image data representative of images showing unexpected or changed road conditions, such as recently commenced road-work. The server(s) 878 may transmit, over the network(s) 890 and to the vehicles, neural networks 892, updated neural networks 892, and/or map information 894, including information regarding traffic and road conditions. The updates to the map information 894 may include updates for the HD map 822, such as information regarding construction sites, potholes, detours, flooding, and/or other obstructions. In some examples, the neural networks 892, the updated neural networks 892, and/or the map information 894 may have resulted from new training and/or experiences represented in data received from any number of vehicles in the environment, and/or based on training performed at a datacenter (e.g., using the server(s) 878 and/or other servers).

The server(s) 878 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 890, and/or the machine learning models may be used by the server(s) 878 to remotely monitor the vehicles.

In some examples, the server(s) 878 may receive data from the vehicles and apply the data to up-to-date real-time neural networks for real-time intelligent inferencing. The server(s) 878 may include deep-learning supercomputers and/or dedicated AI computers powered by GPU(s) 884, such as a DGX and DGX Station machines developed by NVIDIA. However, in some examples, the server(s) 878 may include deep learning infrastructure that use only CPU-powered datacenters.

The deep-learning infrastructure of the server(s) 878 may be capable of fast, real-time inferencing, and may use that capability to evaluate and verify the health of the processors, software, and/or associated hardware in the vehicle 800. For example, the deep-learning infrastructure may receive periodic updates from the vehicle 800, such as a sequence of images and/or objects that the vehicle 800 has located in that sequence of images (e.g., via computer vision and/or other machine learning object classification techniques). The deep-learning infrastructure may run its own neural network to identify the objects and compare them with the objects identified by the vehicle 800 and, if the results do not match and the infrastructure concludes that the AI in the vehicle 800 is malfunctioning, the server(s) 878 may transmit a signal to the vehicle 800 instructing a fail-safe computer of the vehicle 800 to assume control, notify the passengers, and complete a safe parking maneuver.

For inferencing, the server(s) 878 may include the GPU(s) 884 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 9 is a block diagram of an example computing device(s) 900 suitable for use in implementing some embodiments of the present disclosure. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPUs 906 and/or GPUs 908 may include memory (e.g., the memory 904 may be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that enable the computing device 900 to communicate with other computing devices via an electronic communication network, included wired and/or wireless communications. The communication interface 910 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may enable the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that enable detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to enable the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### Example Data Center

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161 (N) may include one or more virtual components, such as vGPUs, vCPUs, and/or the like, and/or one or more of the node C.R.s 1016(1)-1016(N) may correspond to a virtual machine (VM).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1033, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1033 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1033. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016 (N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: storing a first version of a first portion of a map that is compatible with one or more second portions of the map; generating, based at least on sensor data obtained using one or more first machines navigating in a region of an environment corresponding to the first portion of the map, a second version of the first portion of the map; storing, in association with the second version of the first portion of the map, first compatibility data indicating that the one or more second portions of the map are compatible with the second version of the first portion of the map; based at least on the storing of the first compatibility data, updating second compatibility data associated with the one or more second portions of the map to indicate that the first version and the second version of the first portion of the map are compatible with the one or more second portions of the map; and based at least on the updating of the second compatibility data, sending data representative of the second version of the first portion of the map to one or more second machines for use navigating the region of the environment.

B. The method as recited in paragraphs A, wherein: the first compatibility data is stored, at a first time, in a first index that is to store third compatibility data associated with multiple versions of multiple portions of the map; and the method further comprising storing, at a second time after the first time and based at least on a determination that the updating of the second compatibility data is complete, the first compatibility data in a second index that is to store a subset of the third compatibility data associated with latest versions of the multiple portions of the map.

C. The method as recited in any one of paragraphs A-B, further comprising: determining that the updating of the second compatibility data is complete; and based at least on the determining that the updating of the second compatibility data has completed, causing one or more indexes to be updated to indicate at least that the second version of the first portion of the map is a latest version of the first portion of the map.

D. The method as recited in any one of paragraphs A-C, wherein the one or more second portions of the map correspond to one or more second regions of the environment adjacent to the region corresponding to the first portion of the map.

E. The method as recited in any one of paragraphs A-D, wherein the first compatibility data is represented using a compatibility matrix associated with the second version of the first portion of the map, the compatibility matrix indicating one or more geographical locations of one or more second regions of the environment corresponding to the one or more second portions of the map.

F. The method as recited in any one of paragraphs A-E, wherein at least one of: the first compatibility data further indicates one or more third versions of the one or more second portions of the map that are compatible with the second version of the first portion of the map; or the second compatibility data further indicates that the first version and the second version of the first portion of the map are compatible with one or more third versions of the one or more second portions of the map.

G. The method as recited in any one of paragraphs A-F, further comprising: sending, to a machine located in one or more second regions of the environment corresponding to the one or more second portions of the map, first data representative of the one or more second portions of the map; and before the updating of the second compatibility data, sending, to the machine, second data representative of the first version of the first portion of the map for use by the machine to navigate the region of the environment.

H. The method as recited in any one of paragraphs A-G, further comprising: sending, to a machine located in one or more second regions of the environment corresponding to the one or more second portions of the map, first data representative of the one or more second portions of the map; and based at least on at least one of the storing of the first compatibility data or the updating of the second compatibility data, sending, to the machine, second data representative of the second version of the first portion of the map for use by the machine to navigate the region of the environment.

I. A system comprising: one or more processors to: determine that a first portion of a map has been updated from a first version to a second version; store first data indicating the second version of the first portion of the map is compatible with one or more second portions of the map; and based at least on the storage of the first data, cause second data to be updated to indicate that the one or more second portions of the map are compatible with the first version and the second version of the first portion of the map.

J. The system as recited in paragraph I, wherein the first portion of the map corresponds to a first region of an environment and the one or more second portions of the map correspond to one or more second regions of the environment that are adjacent to the first region of the environment such that a first border associated with the first region corresponds to at least a portion of one or more second borders associated with the one or more second regions.

K. The system as recited in any one of paragraphs I-J, wherein: the first data is stored in a first location during a first period of time, the second data is updated in at least one of the first location or a second location during a second period of time after the first period of time, and the one or more processors are further to store the first data in the second location during a third period of time after the second period of time.

L. The system as recited in any one of paragraphs I-K, wherein: the first location is associated with a first index that is to store compatibility data corresponding to multiple versions of multiple portions of the map, and the second location is associated with a second index that is to store a subset of the compatibility data corresponding to current versions of the multiple portions of the map.

M. The system as recited in any one of paragraphs I-L, the one or more processors further to: determine that the second data has been updated; and based at least on the determining that the second data has been updated, cause one or more indexes to be updated to indicate at least that the second version of the first portion of the map is a latest version of the first portion of the map.

N. The system as recited in any one of paragraphs I-M, the one or more processors further to: obtain sensor data generated using one or more machines navigating in a region of the environment corresponding to the first portion of the map; and update the first portion of the map from the first version to the second version based at least on the sensor data.

O. The system as recited in any one of paragraphs I-N, the one or more processors further to: send, to one or more machines located in one or more first regions of the environment corresponding to the one or more second portions of the map, first map data representative of the one or more second portions of the map; and before the second data is updated, sending, to the one or more machines, second map data representative of the first version of the first portion of the map for use by the one or more machines to navigate a second region of the environment corresponding to the first portion of the map.

P. The method as recited in any one of paragraphs I-O, the one or more processors further to: send, to one or more machines located in one or more first regions of the environment corresponding to the one or more second portions of the map, first map data representative of the one or more second portions of the map; and based at least on at least one of the storage of the first data or the second data being updated, send, to the one or more machines, second map data representative of the second version of the first portion of the map for use by the one or more machines to navigate a second region of the environment corresponding to the first portion of the map.

Q. The system as recited in any one of paragraphs I-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

R. One or more processors comprising: one or more circuits to perform one or more operations associated with a machine based at least on obtaining an updated version of a first map corresponding to a first region of an environment, wherein the updated version of the first map is provided to the machine, at least, by: storing, at a first time, first data indicating the updated version of the first map is compatible with one or more second maps corresponding to one or more second regions of the environment; based at least on the storing of the first data, updating, at a second time after the first time, second data to indicate that the one or more second maps are compatible with the updated version and one or more previous versions of the first map; and based at least on the updating of the second data, sending, to the machine, the updated version of the first map for the performance of the one or more operations.

S. The one or more processors as recited in paragraph R, further comprising sending, to one or more second machines, the one or more previous versions of the first map for performance of one or more second operations prior to at least one of the storing of the first data or the updating of the second data.

T. The processor as recited in any one of paragraphs R or S, wherein the processor is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
storing a first version of a first portion of a map that is compatible with one or more second portions of the map;
generating, based at least on sensor data obtained using one or more first machines navigating in a region of an environment corresponding to the first portion of the map, a second version of the first portion of the map;
storing, in association with the second version of the first portion of the map, first compatibility data indicating that the one or more second portions of the map are compatible with the second version of the first portion of the map;
based at least on the storing of the first compatibility data, updating second compatibility data associated with the one or more second portions of the map to indicate that the first version and the second version of the first portion of the map are compatible with the one or more second portions of the map; and
based at least on the updating of the second compatibility data, sending data representative of the second version of the first portion of the map to one or more second machines for use navigating the region of the environment.

2. The method of claim 1, wherein:
the first compatibility data is stored, at a first time, in a first index that is to store third compatibility data associated with multiple versions of multiple portions of the map; and
the method further comprising storing, at a second time after the first time and based at least on a determination that the updating of the second compatibility data is complete, the first compatibility data in a second index that is to store a subset of the third compatibility data associated with latest versions of the multiple portions of the map.

3. The method of claim 1, further comprising:
determining that the updating of the second compatibility data is complete; and
based at least on the determining that the updating of the second compatibility data has completed, causing one or more indexes to be updated to indicate at least that the second version of the first portion of the map is a latest version of the first portion of the map.

4. The method of claim 1, wherein the one or more second portions of the map correspond to one or more second regions of the environment adjacent to the region corresponding to the first portion of the map.

5. The method of claim 1, wherein the first compatibility data is represented using a compatibility matrix associated with the second version of the first portion of the map, the compatibility matrix indicating one or more geographical locations of one or more second regions of the environment corresponding to the one or more second portions of the map.

6. The method of claim 1, wherein at least one of:
the first compatibility data further indicates one or more third versions of the one or more second portions of the map that are compatible with the second version of the first portion of the map; or
the second compatibility data further indicates that the first version and the second version of the first portion of the map are compatible with one or more third versions of the one or more second portions of the map.

7. The method of claim 1, further comprising:
sending, to a machine located in one or more second regions of the environment corresponding to the one or more second portions of the map, first data representative of the one or more second portions of the map; and
before the updating of the second compatibility data, sending, to the machine, second data representative of the first version of the first portion of the map for use by the machine to navigate the region of the environment.

8. The method of claim 1, further comprising:
sending, to a machine located in one or more second regions of the environment corresponding to the one or more second portions of the map, first data representative of the one or more second portions of the map; and
based at least on at least one of the storing of the first compatibility data or the updating of the second compatibility data, sending, to the machine, second data representative of the second version of the first portion of the map for use by the machine to navigate the region of the environment.

9. A system comprising:
one or more processors to:
determine that a first portion of a map has been updated from a first version to a second version;
store first data indicating the second version of the first portion of the map is compatible with one or more second portions of the map; and
based at least on the storage of the first data, cause second data to be updated to indicate that the one or more second portions of the map are compatible with the first version and the second version of the first portion of the map.

10. The system of claim 9, wherein the first portion of the map corresponds to a first region of an environment and the one or more second portions of the map correspond to one or more second regions of the environment that are adjacent to the first region of the environment such that a first border associated with the first region corresponds to at least a portion of one or more second borders associated with the one or more second regions.

11. The system of claim 9, wherein:
the first data is stored in a first location during a first period of time,
the second data is updated in at least one of the first location or a second location during a second period of time after the first period of time, and
the one or more processors are further to store the first data in the second location during a third period of time after the second period of time.

12. The system of claim 11, wherein:
the first location is associated with a first index that is to store compatibility data corresponding to multiple versions of multiple portions of the map, and
the second location is associated with a second index that is to store a subset of the compatibility data corresponding to current versions of the multiple portions of the map.

13. The system of claim 9, the one or more processors further to:
determine that the second data has been updated; and
based at least on the determining that the second data has been updated, cause one or more indexes to be updated to indicate at least that the second version of the first portion of the map is a latest version of the first portion of the map.

14. The system of claim 9, the one or more processors further to:
obtain sensor data generated using one or more machines navigating in a region of the environment corresponding to the first portion of the map; and
update the first portion of the map from the first version to the second version based at least on the sensor data.

15. The system of claim 9, the one or more processors further to:
send, to one or more machines located in one or more first regions of the environment corresponding to the one or more second portions of the map, first map data representative of the one or more second portions of the map; and
before the second data is updated, sending, to the one or more machines, second map data representative of the first version of the first portion of the map for use by the one or more machines to navigate a second region of the environment corresponding to the first portion of the map.

16. The method of claim 9, the one or more processors further to:
send, to one or more machines located in one or more first regions of the environment corresponding to the one or more second portions of the map, first map data representative of the one or more second portions of the map; and
based at least on at least one of the storage of the first data or the second data being updated, send, to the one or more machines, second map data representative of the second version of the first portion of the map for use by the one or more machines to navigate a second region of the environment corresponding to the first portion of the map.

17. The system of claim 9, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

18. One or more processors comprising:
one or more circuits to perform one or more operations associated with a machine based at least on obtaining an updated version of a first map corresponding to a first region of an environment, wherein the updated version of the first map is provided to the machine, at least, by:
storing, at a first time, first data indicating the updated version of the first map is compatible with one or more second maps corresponding to one or more second regions of the environment;
based at least on the storing of the first data, updating, at a second time after the first time, second data to indicate that the one or more second maps are compatible with the updated version and one or more previous versions of the first map; and
based at least on the updating of the second data, sending, to the machine, the updated version of the first map for the performance of the one or more operations.

19. The one or more processors of claim 18, further comprising sending, to one or more second machines, the one or more previous versions of the first map for performance of one or more second operations prior to at least one of the storing of the first data or the updating of the second data.

20. The processor of claim 18, wherein the processor is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
